(19) United States
(12) Patent Application Publication
(10) Pub. No.: US 2026/0175442 A1
(43) Pub. Date: Jun. 25, 2026

(54) MULTI-TYPE ROBOT INTEGRATED CONTROL AND MONITORING DEVICE AND METHOD FOR AUGMENTING ROBOT COMMAND USING ADD-ON DEVICES

(71) Applicant: BIGWAVE ROBOTICS CORP., Seoul (KR)

(72) Inventors: Junbong SONG, Seoul (KR); Mansoo KIM, Seoul (KR); Donghyun LEE, Seoul (KR)

(73) Assignee: BIGWAVE ROBOTICS CORP., Seoul (KR)

(21) Appl. No.: 19/366,966

(22) Filed: Oct. 23, 2025

Related U.S. Application Data
(63) Continuation of application No. PCT/KR2025/014219, filed on Sep. 12, 2025.

(30) Foreign Application Priority Data
Dec. 24, 2024 (KR) 10-2024-0195671
Dec. 24, 2024 (KR) 10-2024-0195678

(51) Int. Cl. B25J 13/08

(52) U.S. Cl. CPC B25J 13/08

(57) ABSTRACT

Disclosed is an integrated control apparatus for multiple types of robots for controlling multiple types of robots being configured to: provide a user environment for the integrated control apparatus for multiple types of robots based on augmented command information regarding a first robot among the multiple types of robots; identify the first function command of the augmented command regarding the first robot received from a user of the integrated control apparatus for multiple types of robots; identify an add-on device mounted on the first robot based on the identifier of the augmented command; determine whether the first robot or the add-on device mounted on the first robot can execute the first function command based on the registration information of the first robot and the add-on device.

### CROSS-REFERENCE TO RELATED APPLICATION

The present application is a continuation of International Patent Application No. PCT/KR2025/014219, filed on Sep. 12, 2025, which is based upon and claims the benefit of priority to Korean Patent Application Nos. 10-2024-0195671 and 10-2024-0195678, filed on Dec. 24, 2024 and Dec. 24, 2024, respectively. The disclosures of the above-listed applications are hereby incorporated by reference herein in their entirety.

### BACKGROUND

Embodiments of the inventive concept described herein relate to an integrated control apparatus and method for multiple types of robots that are capable of augmenting robot commands by using add-on device.

### SUMMARY

The inventive concept provides an integrated control apparatus and method for multiple types of robots that are capable of augmenting robot commands by using add-on device.

The technical objects of the inventive concept are not limited to the above-mentioned ones, and the other unmentioned technical objects will become apparent to those skilled in the art from the following description.

In accordance with an aspect of the inventive concept, there is provided an integrated control apparatus for multiple types of robots for controlling multiple types of robots in an integrated manner, the integrated control apparatus for multiple types of robots for controlling multiple types of robots being configured to: provide a user environment for the integrated control apparatus for multiple types of robots based on augmented command information regarding a first robot among the multiple types of robots; identify the first function command of the augmented command regarding the first robot received from a user of the integrated control apparatus for multiple types of robots; identify an add-on device mounted on the first robot based on the identifier of the augmented command; determine whether the first robot or the add-on device mounted on the first robot can execute the first function command based on the registration information of the first robot and the add-on device; when both the first robot and the add-on device can execute the first function command, determine, based on preset priorities, either the first robot or the add-on device mounted on the first robot to be a representative device that will execute the first function command; based on the result of the determination of the representative device, generate a robot command regarding the first robot or device command regarding the add-on device mounted on the first robot to execute the first function command of the augmented command; and transmit the generated command.

In accordance with another aspect of the inventive concept, there is provided an integrated control method for multiple types of robots for controlling multiple types of robots in an integrated manner, the integrated control method for multiple types of robots for controlling multiple types of robots including: providing a user environment for the integrated control apparatus for multiple types of robots based on augmented command information regarding a first robot among the multiple types of robots; identifying the first function command of the augmented command regarding the first robot received from a user of the integrated control apparatus for multiple types of robots; identifying an add-on device mounted on the first robot based on the identifier of the augmented command; determining whether the first robot or the add-on device mounted on the first robot can execute the first function command based on the registration information of the first robot and the add-on device; when both the first robot and the add-on device can execute the first function command, determining, based on preset priorities, either the first robot or the add-on device mounted on the first robot to be a representative device that will execute the first function command; based on the result of the determination of the representative device, generating a robot command regarding the first robot or device command regarding the add-on device mounted on the first robot to execute the first function command of the augmented command; and transmitting the generated command.

The other detailed items of the inventive concept are described and illustrated in the specification and the drawings.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a diagram schematically showing an example of an environment in which an integrated control apparatus for multiple types of robots according to one embodiment of the inventive concept is provided;

FIG. 2 is a diagram schematically showing a network connection between an integrated control apparatus for multiple types of robots, robots, pieces of automated equipment, and user devices according to one embodiment of the inventive concept;

FIG. 3 is a diagram schematically showing a connection structure between the integrated control apparatus for multiple types of robots, robots, and pieces of automated equipment of FIG. 2;

FIG. 4 is a diagram schematically showing an example of the configuration of the robot of FIG. 1;

FIG. 5 is a diagram schematically showing the configuration of an integrated control apparatus for multiple types of robots according to one embodiment of the inventive concept;

FIG. 6 is a diagram schematically showing the functions or services performed by an integrated control apparatus for multiple types of robots according to one embodiment of the inventive concept;

FIG. 7 is a diagram schematically showing an example of attaching an add-on device to the robot of FIG. 1;

FIG. 8 is a diagram schematically showing an example of the configuration of the add-on device of FIG. 7;

FIG. 9 is a diagram schematically showing an example of attaching add-on devices to the multiple types of robots of FIG. 1;

FIG. 10 is a drawing schematically showing an example of a user environment that is provided by an integrated control apparatus for multiple types of robots according to some embodiments of the inventive concept;

FIG. 11 is a diagram schematically showing a structure in which an integrated control apparatus for multiple types of robots according to some embodiments of the inventive concept augments robot status information by using an add-on device;

FIG. 12 is a diagram schematically showing the simultaneous performance of the augmentation and standardization of the robot status information of FIG. 11;

FIGS. 13 to 15 are diagrams schematically showing various examples of generating augmented status information by processing robot status information;

FIG. 16 is a diagram schematically showing a process in which an integrated control apparatus for multiple types of robots according to some embodiments of the inventive concept processes an augmented robot command by using an add-on device;

FIG. 17 is a diagram schematically showing the simultaneous performance of the processing and standardization of the augmented command of FIG. 16;

FIGS. 18 to 20 are diagrams schematically showing various examples of generating a robot command by processing an augmented command;

FIG. 21 is a diagram schematically showing message conversion using a standardization protocol according to some embodiments of the inventive concept;

FIG. 22 is a diagram schematically showing message conversion using a common standardization protocol and a dedicated standardization protocol according to some embodiments of the inventive concept;

FIG. 23 is a diagram schematically showing estimating missing status data by using a robot database according to some embodiments of the inventive concept;

FIG. 24 is a diagram schematically showing a process of augmenting robot status information in an integrated control method for multiple types of robots according to another embodiment of the inventive concept; and

FIG. 25 is a diagram schematically showing a process of augmenting a robot command in an integrated control method for multiple types of robots according to another embodiment of the inventive concept.

### DETAILED DESCRIPTION OF THE DISCLOSURE

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

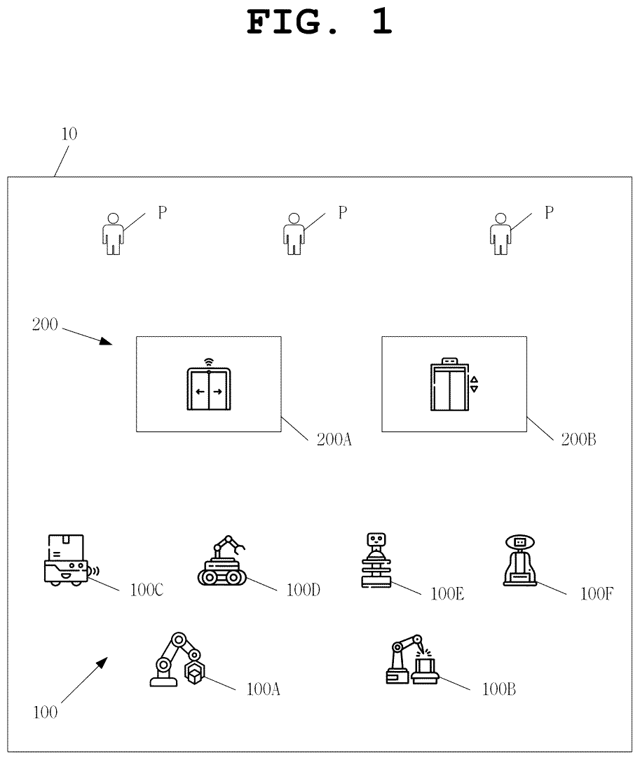

FIG. 1 is a diagram schematically showing an example of an environment in which an integrated control apparatus for multiple types of robots according to one embodiment of the inventive concept is provided.

Referring to FIG. 1, one or more robots 100, one or more pieces of automated equipment 200, and one or more persons P may be present inside a site 10 in which the integrated control apparatus for multiple types of robots is provided.

The site 10 represents a space where the one or more robots 100 are introduced (installed or provided) and controlled. For example, the site 10 may be one of various types of indoor spaces, such as a factory, a hospital, a school, an airport, an apartment, a studio apartment, an office, a restaurant, a government office, a gymnasium, a shopping mall, and a subway station. The site 10 may be a single-story building or a multi-story building having two or more floors. Alternatively, the site 10 may be an outdoor space. Meanwhile, a plurality of sites may be implemented within a single space as needed. For example, when the first and second floors of a building are designated as separate sites 10, the first floor may be designated as a first site 10, and the second floor may be designated as a second site 10.

Multiple types of robots 100A to 100F may be present within the site 10.

The “robot” refers to a mechanical device programmed to perform a variety of tasks. The robot includes robots having a variety of applications and functions utilized in various industrial and service fields. For example, the robot includes various types of robots such as: industrial robots, such as Cartesian robots, multi-joint robots, SCARA robots, and delta robots; collaborative robots; logistics robots; unmanned forklifts; cleaning robots; serving robots; delivery robots; guide robots; cooking robots; barista robots; security robots; medical robots; quadrupedal robots; military robots; space exploration robots; deep-sea exploration robots; and humanoid robots.

In the present specification, the “multiple types of robots” refers to a case where two or more different types of robots are present. Not only a case where two or more robots having different purposes are present but also a case where two or more robots having the same purpose but different manufacturers are present may be represented by the “multiple types of robots.” Since the object of the inventive concept is to implement the integrated control of multiple types of robots, the “multiple types of robots” may be broadly defined as cases where message format differ due to differences in hardware components or software algorithms, regardless of whether two or more robots have the same purpose, manufacturer, or combination thereof. The “multiple types of robots” may also be represented by “multiple heterogeneous robots.”

Inside the site 10, there may be the one or more pieces of automated equipment 200 in addition to the robots 100. Multiple pieces of automated equipment 200A and 200B having various purposes and functions may be implemented inside the site 10. For example, the pieces of automated equipment 200 may include, but are not limited to, various pieces of automated equipment implemented for human movement, such as an automatic door, an elevator, an escalator, and a speed gate. The pieces of automated equipment 200 may support the movement of the robots 100 by performing actions, such as boarding the robot 100 or allowing the robot 100 to pass through the automated equipment, in conjunction with the integrated control apparatus for multiple types of robots.

Inside the site 10, there may be the one or more persons P who interact with the robot 100 or automated equipment 200. The persons P may each perform various roles depending on the situation. For example, each of the persons P may be an engineer operating a manufacturing robot 100A, a worker working in the same space as a logistics robot 100C, or a customer receiving food from a serving robot 100E, but is not limited thereto. The robots 100 may perform obstacle avoidance to avoid a collision with the person P. When a collision with the person P is anticipated, the robot 100 may pause temporarily or control its drive unit to a path different from a current path.

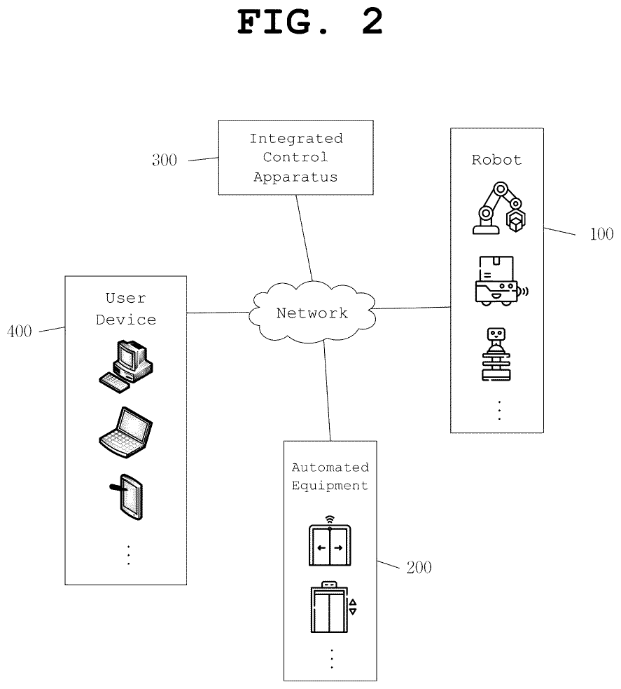

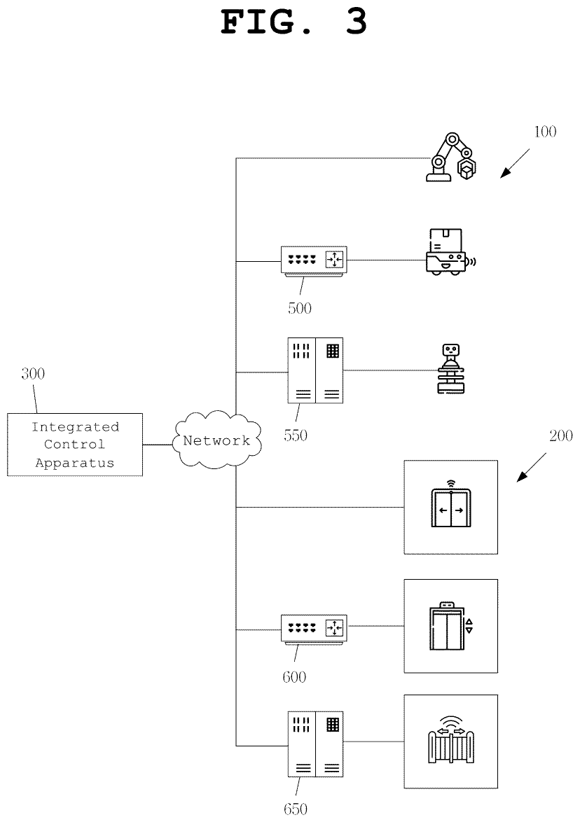

FIG. 2 is a diagram schematically showing a network connection between an integrated control apparatus for multiple types of robots, robots, pieces of automated equipment, and user devices according to one embodiment of the inventive concept, and FIG. 3 is a diagram schematically showing a connection structure between the integrated control apparatus for multiple types of robots, robots, and pieces of automated equipment of FIG. 2.

Referring to FIG. 2, robots 100, pieces of automated equipment 200, an integrated control apparatus 300, and user devices 400 are connected to a network. The robots 100, the pieces of automated equipment 200, the integrated control apparatus 300, and the user devices 400 may transmit and receive various types of data or information over the network.

The network may include a wired network, a wireless network, or a combination thereof capable of transmitting and receiving various types of data or information.

The integrated control apparatus 300 performs integrated control for multiple types of robots 100 introduced into at least one site 10.

The integrated control apparatus 300 may remotely control the operations of the robots 100 by transmitting command messages to the robots 100. The integrated control apparatus 300 may monitor the statuses of the robots 100 in real time by receiving status messages from the robots 100.

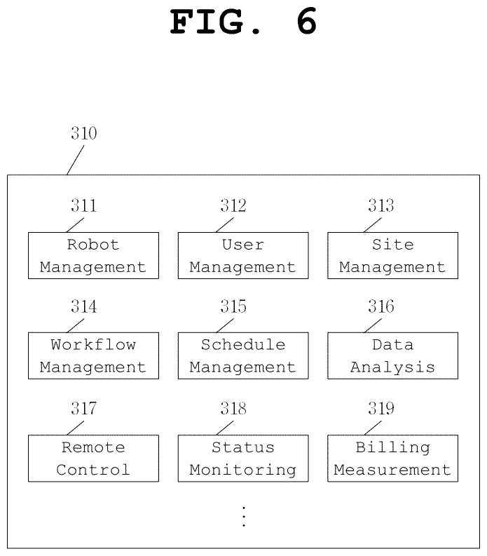

In addition, the integrated control apparatus 300 may perform various control-related functions, which will be described later with reference to FIG. 6. The integrated control apparatus 300 may be implemented in an on-premise system structure inside the site 10, or may be implemented in a cloud system structure outside the site 10.

The user devices 400 each refer to a computing system operated by a user who uses the integrated control apparatus 300. The user devices 400 may each receive commands to perform specific actions from a user, and may output the results of performing the actions to the user. The user devices 400 may include various input and output devices well known in the art to which the inventive concept pertains. For example, the user devices 400 may include, but are not limited to, a smartphone, a desktop computer, a laptop computer, a tablet PC, a smart TV, a digital signage, a wearable device, and/or the like.

Referring to FIG. 3, the connection structure for the transmission and reception of data or information between the integrated control apparatus 300 and the robot 100 may vary. For example, the integrated control apparatus 300 may be directly connected to the robot 100 (or the control panel of the robot 100) over a network, and may transmit and receive messages to and from the robot 100. Alternatively, the integrated control apparatus 300 may be connected to the robot 100 via a relay device 500, and may transmit and receive messages to and from the robot 100. The relay device 500 may include middleware required for communication between the integrated control apparatus 300 and the robot 100, which use different communication methods. For example, the relay device 500 may communicate with the integrated control apparatus 300 via an Application Programming Interface (API) and communicate with the robot 100 by using an industrial communication method such as Modbus, thereby relaying communication between the integrated control apparatus 300 and the robot 100. Alternatively, the integrated control apparatus 300 may be connected to the robot 100 via the manufacturer server 550 of the manufacturer of the robot 100. For example, the integrated control apparatus 300 may communicate with the manufacturer server 550 by using one of various API methods, such as a Representational State Transfer (REST) API and a WebSocket API. The integrated control apparatus 300 may transmit and receive messages to and from the robot 100 via the manufacturer server 550.

The connection structure for the transmission and reception of data or information between the integrated control apparatus 300 and the automated equipment 200 may vary. For example, the integrated control apparatus 300 may be directly connected to the automated equipment 200 over the network, and may transmit and receive messages to and from the automated equipment 200. Alternatively, the integrated control apparatus 300 may be connected to the automated equipment 200 via a relay device 600, and may transmit and receive messages to and from the automated equipment 200. The relay device 600 may include middleware required for communication between the integrated control apparatus 300 and the automated equipment 200, which use different communication methods. For example, the relay device 600 may communicate with the integrated control apparatus 300 via an API and communicate with the automated equipment 200 by using an industrial communication method such as Modbus, thereby relaying communication between the integrated control apparatus 300 and the automated equipment 200. Alternatively, the integrated control apparatus 300 may be connected to the automated equipment 200 via the manufacturer server 650 of the manufacturer of the automated equipment 200. For example, the integrated control apparatus 300 may communicate with the manufacturer server 650 by using various API methods, such as a REST API or a WebSocket API. The integrated control apparatus 300 may transmit and receive messages to and from the automated equipment 200 via the manufacturer server 650.

Although not explicitly shown in FIG. 3, the relay device 600 may be directly connected to the automation equipment 200, or may be connected to the automation equipment 200 via the monitoring or control panel system of the automation equipment 200.

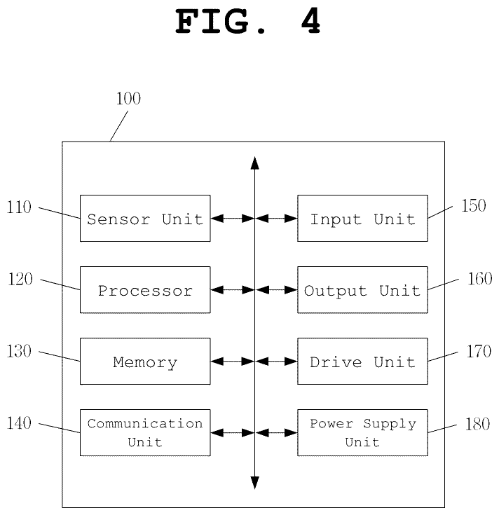

FIG. 4 is a diagram schematically showing an example of the configuration of the robot of FIG. 1.

Referring to FIG. 4, the robot 100 includes a sensor unit 110, a processor 120, memory 130, a communication unit 140, an input unit 150, an output unit 160, a drive unit 170, and a power supply unit 180.

The sensor unit 110 may include one or more sensors for sensing the surrounding environment of the robot 100, the status of a specific internal component of the robot 100, the position of the robot 100, the operator of the robot 100, and/or the like. For example, the sensor unit 110 may include, but is not limited to, an image sensor, an RGBD sensor, a Light Detection And Ranging (LIDAR) sensor, a laser sensor, an ultrasonic sensor, a proximity sensor, an infrared sensor, a force/torque sensor, an inertial sensor, a gyro sensor, an acceleration sensor, a temperature sensor, and/or the like.

The processor 120 performs the general control of the robot 100. The processor 120 may control other internal components of the robot 100, such as the sensor unit 110, the memory 130, the communication unit 140, the input unit 150, the output unit 160, the drive unit 170, and the power supply unit 180. The processor 120 may be implemented to include a Central Processing Unit (CPU), a Micro Processor Unit (MPU), a Micro Controller Unit (MCU), a Graphics Processing Unit (GPU), and/or any other type of processor well known in the art to which the inventive concept pertains. The processor 120 may read one or more instructions or computer programs stored in the memory 130 and execute various commands. The processor 120 may control the robot 100 according to command messages received from the integrated control apparatus 300 via the communication unit 140.

The memory 130 stores one or more instructions, one or more computer programs, data, and/or information for the operation of the robot 100. For example, the memory 130 may include random access memory (RAM), (ROM), read only memory erasable programmable ROM (EPROM), electrically erasable programmable ROM (EEPROM), flash memory, a hard disk, a removable disk, a CD-ROM, and/or any other type of computer-readable storage medium well known in the art to which the inventive concept pertains.

The communication unit 140 may include a wired communication unit, a wireless communication unit, or a combination thereof. The wireless communication unit may include, for example, one or more of a mobile communication module, a wireless Internet module, and a short-range communication module. The mobile communication module may transmit and receive wireless signals to and from at least one of a base station, an external terminal, and a server on a mobile communication network constructed according to mobile communication technology standards or communication methods. The wireless Internet module may transmit and receive wireless signals on a communication network based on wireless Internet technologies. The short-range communication module is intended for short-range communication, and may support short-range communication by using at least one of Bluetooth, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies.

The input unit 150 may include a camera for inputting video signals, a microphone for receiving audio signals, and a user input unit for receiving information from a user. The image or voice data collected by the input unit 150 may be analyzed and processed into user commands. The user input unit 150 may include a mechanical input means or a touch input means.

The output unit 160 may include one or more of a display unit, an audio output unit, a haptic module, and an optical output unit for generating output related to a visual, auditory, or tactile sensation.

The drive unit 170 provides a means for driving mechanical components of the robot 100. For example, in the case of a manufacturing robot or a quadruped robot, the drive unit 170 includes a means for driving the joints of the robot 100. In the case of a mobile robot, the drive unit 170 may include various means for performing functions such as driving and changing the direction of the robot 100. The drive unit 170 may include various actuators, such as a motor and a reducer.

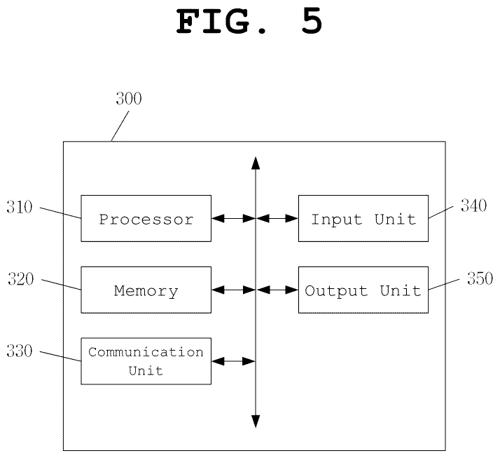

The power supply unit 180 supplies power for the operation of the robot 100. The power supply unit 180 supplies external power or the internal power (e.g., power from a battery) of the robot 100 to the individual internal components of the robot 100. FIG. 5 is a diagram schematically showing the configuration of an integrated control apparatus for multiple types of robots according to one embodiment of the inventive concept.

Referring to FIG. 5, an integrated control apparatus 300 for multiple types of robots includes a processor 310, memory 320, a communication unit 330, an input unit 340, and an output unit 350.

The processor 310 performs the general control of the integrated control apparatus 300 for multiple types of robots. The processor 310 may control other internal components of the integrated control apparatus 300 for multiple types of robots, such as the memory 320, the communication unit 330, the input unit 340, and the output unit 350. The processor 310 may be implemented to include a CPU, an MPU, an MCU, a GPU, or any other type of processor well known in the art to which the inventive concept pertains. The processor 310 may read one or more instructions or computer programs stored in the memory 320 and execute various commands. The processor 310 may control the integrated control apparatus 300 for multiple types of robots according to the commands received from the user devices 400 via the communication unit 330.

The memory 320 stores one or more instructions, one or more computer programs, data, and/or information for the operation of the integrated control apparatus 300 for multiple types of robots. For example, the memory 320 may include RAM, ROM, EPROM, EEPROM, flash memory, a hard disk, a removable disk, a CD-ROM, or any other type of computer-readable storage medium well known in the art to which the inventive concept pertains.

The communication unit 330 may include a wired communication unit, a wireless communication unit, or a combination thereof. The wireless communication unit may include, for example, one or more of a mobile communication module, a wireless Internet module, and a short-range communication module. The mobile communication module may transmit and receive wireless signals to and from at least one of a base station, an external terminal, and a server on a mobile communication network constructed according to mobile communication technology standards or communication methods. The wireless Internet module may transmit and receive wireless signals on a communication network based on wireless Internet technologies. The short-range communication module is intended for short-range communication, and may support short-range communication by using at least one of Bluetooth, RFID, infrared communication, UWB, ZigBee, NFC, Wi-Fi, Wi-Fi Direct, and Wireless USB technology.

The input unit 340 may include a camera for inputting video signals, a microphone for receiving audio signals, and a user input unit for receiving information from the user. The image data or voice data collected by the input unit may be analyzed and processed into user commands. The user input unit may include a mechanical input device or a touch input device.

The output unit 350 may include one or more of a display unit, an audio output unit, a haptic module, and an optical output unit for generating output related to a visual, auditory, or tactile sensation.

The integrated control apparatus 300 for multiple types of robots may be implemented as a single server or multiple servers as needed. When the integrated control apparatus 300 for multiple types of robots is implemented as multiple servers, each of the servers may include the configuration described with reference to FIG. 5.

FIG. 6 is a diagram schematically showing the functions or services performed by an integrated control apparatus multiple types of robots according to one embodiment of the inventive concept.

Referring to FIG. 6, the processor 310 of the integrated control apparatus 300 for multiple types of robots may execute one or more instructions or computer programs stored in the memory 320, thereby providing various functions or services, such as robot management 311, user management 312, site management 313, workflow management 314, schedule management 315, data analysis 316, remote control 317, status monitoring 318, and billing measurement 319.

For example, the integrated control apparatus 300 for multiple types of robots may provide a robot management function that registers and manages robot types, robot names, and robot identifiers. Furthermore, the integrated control apparatus 300 for multiple types of robots may provide a user management function that registers and manages users having management authority for the respective robots 100. To this end, the integrated control apparatus 300 for multiple types of robots may associate and register robot identifiers, user identifiers, user passwords, and/or the like. Furthermore, the integrated control apparatus 300 for multiple types of robots may provide a site management function that registers and manages site types, site names, site addresses, site floor numbers, site maps, site robots, and points of interest within sites. A user may assign robots, for which he or she has management authority, for each site. Furthermore, the integrated control apparatus 300 for multiple types of robots may provide a workflow management function that constructs, modifies, and manages workflows each defining the sequence of a series of tasks, and controls and monitors the robots 100 according to the workflows. Furthermore, the integrated control apparatus 300 for multiple types of robots may provide a schedule management function that controls each of the robots 100 to perform a predetermined task at a specific time or to repeatedly perform the corresponding task. Furthermore, the integrated control apparatus 300 for multiple types of robots may provide a data analysis function that analyzes various types of data regarding the statuses received from the robots 100 or the commands transmitted to the robots 100 and provides data status and statistics. Furthermore, the integrated control apparatus 300 for multiple types of robots may provide a remote control function that remotely instructs the robots 100 and controls their operations. Furthermore, the integrated control apparatus 300 for multiple types of robots may provide a status monitoring function that monitors various conditions of the robots 100, such as their operational statuses, battery levels, and current locations, in real time. Furthermore, the integrated control apparatus 300 for multiple types of robots may perform a billing measurement function that determines the billing amounts based on the computing resource consumptions of the robots 100, the numbers of network transmissions, and/or the like. The integrated control apparatus 300 for multiple types of robots may provide various functions or services, such as preemptive (preventive) repair & maintenance, remote error resolution, and/or the like, which are not shown in FIG. 6.

So far, the integrated control apparatus 300 for multiple types of robots according to one embodiment of the inventive concept has been described with reference to FIGS. 1 to 6. The augmentation of robot status information and robot commands using an add-on device will be described below.

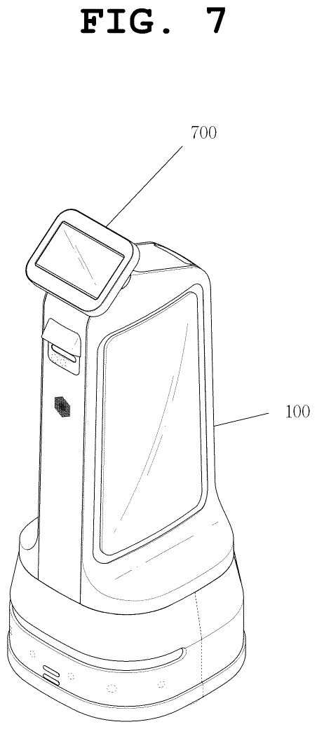

FIG. 7 is a diagram schematically showing an example of attaching an add-on device to the robot of FIG. 1.

Referring to FIG. 7, an add-on device 700 intended to augment the performance or functionality of a robot 100 may be attached to the robot 100.

For example, as shown in FIG. 7, the add-on device 700 may be attached to the surface of the outer shape of the robot 100, or may be attached to the inside of the robot 100 so that it is not visible from the outside of the robot 100.

The add-on device 700 refers to an auxiliary device added to improve, augment, or expand the performance or functionality of the robot 100.

As described above, the add-on device 700 may be utilized to overcome differences in hardware or software between a plurality of robots 100 that occur in an integrated control environment for multiple types of robots.

The add-on device 700 may augment the robot status information and robot commands of the robot 100.

The add-on device 700 may be implemented as a device that can operate independently of the robot 100.

The add-on device 700 is connected to a network. The integrated control apparatus 300 and the add-on device 700 may transmit and receive various types of data or information to and from each other over the network.

The integrated control apparatus 300 performs integrated control on multiple types of robots 100 introduced into at least one site 10 and add-on devices 700 mounted on at least some of the multiple types of robots 100.

The integrated control apparatus 300 may control the operation of the add-on device 700 by remotely transmitting device commands to the add-on device 700. The integrated control apparatus 300 may monitor the status of the add-on device 700 in real time by receiving device status information from the add-on device 700.

The add-on device 700 may augment the robot status information collected via the multiple types of robots 100 by including various sensors. In an integrated control environment for multiple types of robots, the sensor provided within the robot 100 may vary with the manufacturer or some robots 100 may lack specific sensors, so that ambient environment information that can be collected may vary with the robot 100. By utilizing the add-on device 700, it may be possible to supplement the collection of the ambient environment information, required by the integrated control apparatus 300 for multiple types of robots, in terms of hardware.

The add-on device 700 may include sensors capable of collecting various types information to augment the of performance or functionality of the robot 100. The add-on device 700 may include at least one sensor having the same type as at least one sensor included in the robot 100. Even when the robot 100 already includes a type of sensor, the add-on device 700 may include the same type of sensor that has relatively high performance or different specifications compared to the sensor included in the robot 100. The add-on device 700 may include a different type of sensor not included in the robot 100 and collect information that the robot 100 cannot collect.

Furthermore, the add-on device 700 may augment the robot commands executed by multiple types of robots 100 by including various types of output devices. In an integrated control environment for multiple types of robots, the commands that can be executed may vary with the robot 100 because the output devices provided within the robot 100 may vary with the manufacturer or some robots 100 may lack specific output devices. Even when some robots 100 are equipped with specific output devices, specific functions utilizing these output devices may be disabled. By utilizing the add-on device 700, it may be possible to supplement the execution of the output device and functionality, required by the integrated control apparatus 300 for multiple types of robots, in terms of hardware.

The add-on device 700 may include output devices capable of executing various functions to augment the performance or functionality of the robot 100. The add-on device 700 may include one or more output devices capable of executing the same type of functions as one or more output devices included in the robot 100. Even when the robot 100 already includes a type of output device, the add-on device 700 may include the same type of output device that has relatively high performance or different specifications compared to the output device included in the robot 100. The add-on device 700 may execute a function that the robot 100 cannot execute by including an output device capable of executing a different type of function not included in the robot 100.

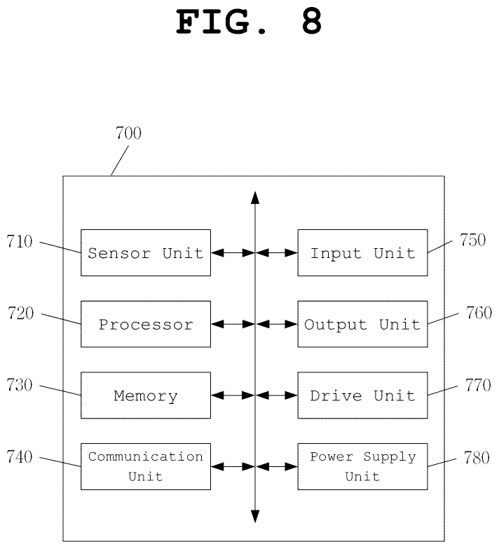

FIG. 8 is a diagram schematically showing an example of the configuration of the add-on device of FIG. 7.

Referring to FIG. 8, the add-on device 700 may have a configuration similar to that of the robot 100 in that it is intended to augment the performance or functionality of the robot 100.

The add-on device 700 includes a sensor unit 710, a processor 720, memory 730, a communication unit 740, an input unit 750, an output unit 760, a drive unit 770, and a power supply unit 780.

The sensor unit 710 may include one or more sensors for sensing and collecting information about the surrounding environment of the robot 100, the statuses of specific internal components of the add-on device 700, the location of the robot 100, the operator of the robot 100, and/or the like when the add-on device 700 is mounted on the robot 100. For example, the sensor unit 710 may include, but is not limited to, a distance sensor, a collision detection sensor, a Light Detection and Ranging (lidar) sensor, an image sensor, an RGBD sensor, a laser sensor, an ultrasonic sensor, a proximity sensor, an infrared sensor, a force/torque sensor, an inertial sensor, a gyro sensor, an acceleration sensor, a temperature sensor, and the like.

The processor 720 performs the general control of the add-on device 700. The processor 720 may control other internal components of the robot 100, such as the sensor unit 710, the memory 730, the communication unit 740, the input unit 750, the output unit 760, the drive unit 770, and the power supply unit 780. The processor 720 may be implemented to include a CPU, an MPU, an MCU, a GPU, or any other type of processor well known in the art to which the inventive concept pertains. The processor 720 may read one or more instructions or computer programs stored in the memory 730 and execute various commands. The processor 720 may control the add-on device 700 according to the command messages of the integrated control apparatus 300 for multiple types of robots received via the communication unit 740.

The memory 730 stores one or more instructions, one or more computer programs, data, and/or information for the operation of the add-on device 700. For example, the memory 730 may include random access memory (RAM), read only memory (ROM), erasable programmable ROM (EPROM), electrically erasable programmable ROM (EEPROM), flash memory, a hard disk, a removable disk, a CD-ROM, and/or any other type of computer-readable storage medium well known in the art to which the inventive concept pertains.

The communication unit 740 may include a wired communication unit, a wireless communication unit, or a combination thereof. The wireless communication unit may include, for example, one or more of a mobile communication module, a wireless Internet module, and a short-range communication module. The mobile communication module may transmit and receive wireless signals to and from at least one of a base station, an external terminal, and a server on a mobile communication network constructed according to mobile communication technology standards or communication methods. The wireless Internet module may transmit and receive wireless signals on a communication network based on wireless Internet technologies. The short-range communication module is intended for short-range communication, and may support short-range communication by using at least one of Bluetooth, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies.

The input unit 750 may include a camera for inputting video signals, a microphone for receiving audio signals, and a user input unit for receiving information from a user. The image or voice data collected by the input unit 750 may be analyzed and processed into user commands. The user input unit 750 may include a mechanical input means or a touch input means. In this case, the “user” refers to a user using the integrated control apparatus 300 or a person directly interacting with the robot 100 or add-on device 700.

The output unit 760 may include one or more of a display unit, an audio output unit, a haptic module, and an optical output unit for generating output related to a visual, auditory, or tactile sensation. Furthermore, the output unit 760 may include one or more signal output units capable of outputting predetermined signals required for integrated control, such as RF signals or Bluetooth signals.

The drive unit 170 provides a means for driving mechanical parts of the add-on device 700. For example, the add-on device 700 may include predetermined mechanical parts, such as the joints or wheels of the robot 100. The drive unit 770 may include various actuators, such as a motor or a reducer.

The add-on device 700 may include various output devices by including various output units 760 and drive units 770 that are not illustrated in the drawings. For example, the add-on device 700 may include an output device that transmits predetermined RF signals.

The power supply unit 780 supplies power for the operation of the add-on device 700. The power supply unit 780 supplies external power or internal power (e.g., the power of a battery) to the internal components of the add-on device 700.

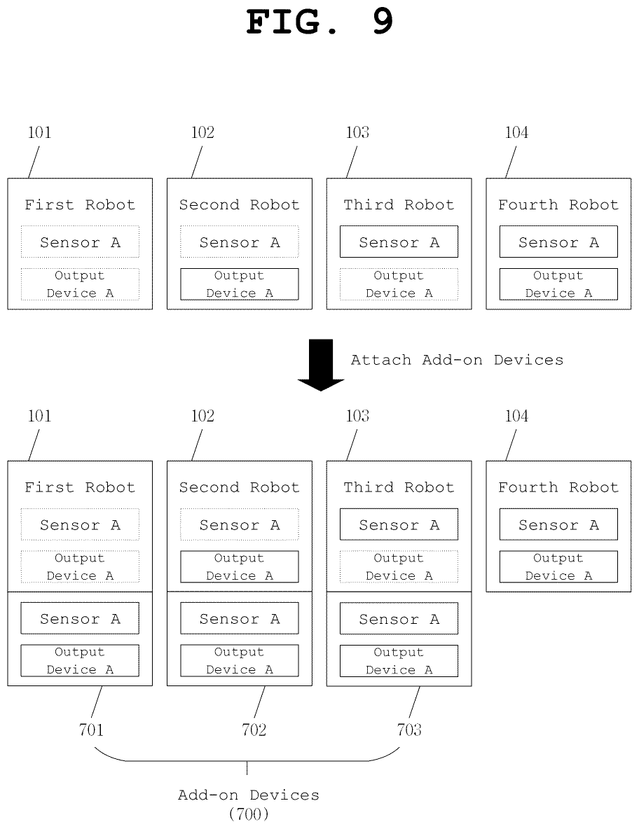

FIG. 9 is a diagram schematically showing an example of attaching add-on devices to the multiple types of robots of FIG. 1.

Referring to FIG. 9, there are provided add-on devices 700 each equipped with the standardized configuration of a sensor and an output device regardless of the sensor or output device included in the robot 100. However, the inventive concept is not limited thereto.

To augment the performance or functionality of the multiple types of robots 100, there may be provided multiple types of add-on devices 700 equipped with configurations each optimized for the specifications or performance of a corresponding one of the multiple types of robots 100.

Depending on the specifications or performance of the multiple types of robots 100 constructed in the site, the add-on device 700 may include a sensor and/or an output device included in at least some of the robots 100, or may include a sensor and/or an output device not provided in at least some of the robots 100. Furthermore, the same add-on devices 700 may be mounted on at least some of the robots 100.

In the example of FIG. 9, it is assumed that add-on devices 700 each equipped with a standardized configuration is provided to reduce manufacturing costs.

In the example of FIG. 9, it is assumed that a first robot 101 includes neither sensor A nor output device A, a second robot 102 does not include sensor A, a third robot 103 does not include output device A, and a fourth robot 104 includes both sensor A and output device A. The block drawn with a dotted line in FIG. 9 indicates that the robot 100 does not include a corresponding component. The output device includes the output unit 760 or drive unit 170 described above.

These differences in specifications may be overcome by attaching an add-on device 700, containing both sensor A and output device A, to each of the robots 101, 102, and 103 each of which does not include either sensor A or output device A or includes neither sense A nor output device A.

With this, the first robot 101, the second robot 102, and the third robot 103—more precisely, the robot assemblies for the respective robots—may collect environmental information and execute predetermined function commands in substantially the same manner as the fourth robot 104.

Since it is assumed that the add-on devices 700 each equipped with a standardized configuration are provided, the robot assemblies for some robots 120 and 103 may include a redundant sensor or output device.

As shown in FIG. 9, by attaching add-on devices 701, 702, and 703 each containing sensor A and output device A to the first robot 101, the second robot 102, and the third robot 103, respectively, the integrated control apparatus 300 for multiple types of robots may enable the multiple types of robots 101, 102, 103, and 104 to collect predetermined information by using sensor A and execute predetermined function commands by using output device A with consistent quality and performance.

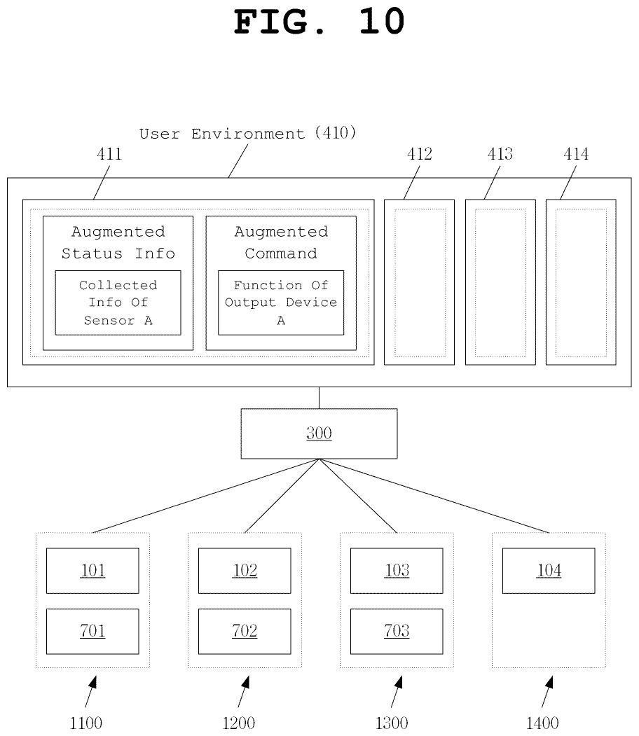

FIG. 10 is a drawing schematically showing an example of a user environment that is provided by an integrated control apparatus for multiple types of robots according to some embodiments of the inventive concept.

Referring to FIG. 10, the integrated control apparatus 300 for multiple types of robots provides a user environment for the integrated control apparatus 300 for multiple types of robots based on augmented status information or information about an augmented command of the robot 100.

The “augmented status information” refers to the robot status information augmented by merging the robot status information received from the robot 100 and the device status information received from the add-on device 700 with each other. Providing a user environment based on augmented status information of the robot 100 means providing a user environment based not only on the information collected using a sensor inherently included in the robot 100 but also on the information collected by the add-on device 700 mounted on the robot 100.

The “augmented command” refers to a robot command augmented by merging a robot command transmitted to the robot 100 and a device command transmitted to the add-on device 700 with each other.

Providing a user environment based on information about an augmented command of the robot 100 means providing a user environment based not only on a function command executable using the output device inherently included in the robot 100 but also on information about a function command executable by the add-on device 700 mounted on the robot 100.

The integrated control apparatus 300 for multiple types of robots generates augmented status information by merging robot status information and device status information with each other within the system, and similarly, divides an augmented command into a robot command and a device command within the system.

In connection with device status information and a device command, the integrated control apparatus 300 for multiple types of robots implements a user environment that allows a user outside the system to perceive information as if it were collected by the robot 100 by using its inherent sensor and perceive a function command as if it were a function command executed by the robot 100 by using its inherent output device.

To this end, in connection with the robot 100 equipped with the add-on device 700, the integrated control apparatus 300 for multiple types of robots provides an integrated user environment regarding at least robot status information, device status information, robot commands, and device commands.

In the example of the user environment shown in FIG. 10, the integrated control apparatus 300 for multiple types of robots may provide user interfaces 411, 412, 413, and 414, which are at least partially the same, for the first robot 101, the second robot 102, the third robot 103, and the fourth robot 104 regardless of the sensor or output device that the first robot 101, the second robot 102, the third robot 103, and the fourth robot 104 inherently include.

In connection with a first robot assembly 1100 including the first robot 101 and the add-on device 701 mounted on the first robot 101, a second robot assembly 1200 including the second robot 102 and the add-on device 702 mounted on the second robot 102, a third robot assembly 1300 including the third robot 103 and the add-on device 703 mounted on the third robot 103, and the fourth robot 104 or a fourth robot assembly 1400, they are common in that they can collect predetermined information by using sensor A and execute a predetermined function command by using output device A, as described above. Accordingly, the integrated control apparatus 300 for multiple types of robots may provide user interfaces in which the interface portions related to sensor A and output device A are the same.

Each of the robots 101, 102, 103, and 104 may further include a sensor or an output device other than sensor A and output device A included in each of the add-on devices 701, 702, and 703. An interface portion different from those of other robots may be provided in connection with a unique sensor or output device that each of the robots 101, 102, 103, and 104 includes.

The integrated control apparatus 300 for multiple types of robots may interact with the first robot assembly 1100 by using the first user interface 411, may interact with the second robot assembly 1200 by using the second user interface 412, may interact with the third robot assembly 1300 by using the third user interface 413, and may interact with the fourth robot 104 or the fourth robot assembly 1400 by using the fourth user interface 414.

Through these interfaces, the user may experience information as if it were collected using unique sensor A inherently possessed by each robot 100, and may also experience a command as if it were a function command executed using unique output device A inherently possessed by each robot 100.

The user environment 410 may include components for various hardware or software environments required for the user to effectively use the integrated control apparatus 300 for multiple types of robots, in addition to the user interfaces, which serve as tools for interaction with the user.

As previously described, when the integrated control apparatus 300 for multiple types of robots provides a user environment (including user interfaces) based on the augmented status information obtained by merging robot status information and device status information with each other and augmented command information obtained by merging robot and device commands other, the integrated control apparatus 300 for with each multiple types of robots needs to perform a series of processes to process the robot status information and robot commands inside the system.

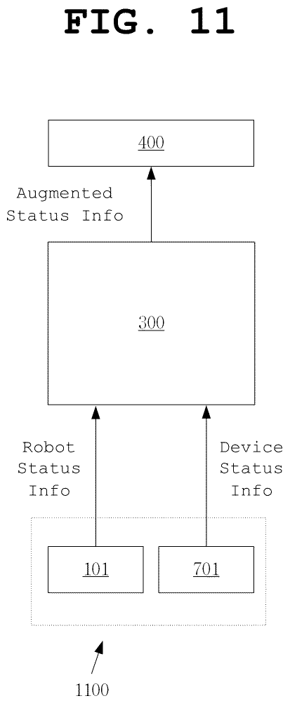

FIG. 11 is a diagram schematically showing a structure in which an integrated control apparatus for multiple types of robots according to some embodiments of the inventive concept augments robot status information by using an add-on device. For ease of description, the case of generating augmented status information based on the robot status information received from a first robot there will be described as a representative example.

Referring to FIG. 11, an integrated control apparatus 300 for multiple types of robots receives robot status information from a first robot 101 of multiple types of robots 100.

The integrated control apparatus 300 for multiple types of robots receives robot status information from the first robot 101 and device status information from an add-on device 701 mounted on the first robot 101.

The integrated control apparatus 300 for multiple types of robots identifies the first collection information of the robot status information received from the first robot 101. The first collection information of the robot status information represents information collected using a predetermined sensor within the first robot 101. The robot status information may further include various types of information collected using various sensors in addition to the above-described sensor.

In addition, the integrated control apparatus 300 for multiple types of robots may identify the add-on device 701 mounted on the first robot 101 based on the identifier of the robot status information.

To enable the integrated control apparatus 300 for multiple types of robots to identify each of the robot 100 and the add-on device 700, each of the robot 100 and the add-on device 700 may be assigned a predetermined identifier. Furthermore, the status information, augmented status information, and augmented commands transmitted by the robot 100 or add-on device 700, and the commands transmitted to the robot 100 or add-on device 700 may include these identifiers.

In some embodiments, at least a portion of the identifier of the add-on device 700 mounted on the predetermined robot 100 may be identical to at least a portion of the identifier of the robot 100. Alternatively, the add-on device 700 may have an identifier completely identical to that of the robot 100. In this case, the status information or command may further include the device type information used to distinguish the robot or add-on device, in addition to the identifier.

In some embodiments, the identifier of the predetermined robot 100 and the identifier of the add-on device 700 mounted on the robot 100 may be mapped to each other and stored in a robot database (not shown) inside the integrated control apparatus 300 for multiple types of robots.

The integrated control apparatus 300 for multiple types of robots identifies the second collection information of the device status information received from the add-on device 701 mounted on the first robot 101. The second collection information of the device status information represents information collected using a predetermined sensor within the add-on device 701. The device status information may further include various types of information collected using various sensors in addition to the above-described sensor.

The integrated control apparatus 300 for multiple types of robots determines whether the first collection information received from the first robot 101 and the second collection information received from the add-on device 701 overlap each other. The integrated control apparatus 300 for multiple types of robots determines whether there is overlapping collection information between the various types of collection information received from the first robot 101 and the various types of collection information received from the add-on device 701.

The integrated control apparatus 300 for multiple types of robots may determine whether the first and second collection information overlap each other based on preset criteria.

In some embodiments, as described below, when the first sensor within the first robot 101 that has collected the first collection information and the second sensor within the add-on device 701 that has collected the second collection information are of the same type, the integrated control apparatus 300 for multiple types of robots may determine that the first collection information and the second collection information overlap each other. For example, when both the first robot 101 and the add-on device 701 have distance sensors for measuring distances to surrounding objects, the integrated control apparatus 300 for multiple types of robots may determine that the first collection information and second collection information collected by the same type of distance sensors overlap each other.

When the first collection information and the second collection information overlap each other, i.e., when pieces of information collected using the same type of sensors within the first robot assembly 1100 overlap each other, the integrated control apparatus 300 for multiple types of robots needs to perform an additional procedure required to address a problem of overlapping regarding the collected information.

In some embodiments, the integrated control apparatus 300 for multiple types of robots may determine either the first collection information or the second collection information to be representative collection information, and may not utilize the remaining collection information, not determined to be representative collection information, in an augmented status information generation process to be described later.

In some embodiments, priorities for the determination of representative collection information may be preset and stored in database (not shown) inside the integrated control a robot apparatus 300 for multiple types of robots. The priorities may be set on a per-user or per-robot (per-add-on device) basis. For example, a user may set priorities for all robots 100, for which he or she has authority, so that the collection information of the robot 100 is determined to be representative collection information or the collection information of the add-on device 700 is determined to be representative collection information. Alternatively, a user may set a priority for one of robots 100, for which he or she has authority, so that the collection information of the robot 100 is determined to be representative collection information and set a priority for another robot 100 so that the collection information of the add-on device 700 is determined to be representative collection information. Alternatively, the priorities may be set for respective pieces of collection information.

In some embodiments, the integrated control apparatus 300 for multiple types of robots may determine either the first collection information or the second collection to be representative collection information based the priorities.

The integrated control apparatus 300 for multiple types of robots generates augmented status information regarding the first robot 101 by merging the robot status information and the device status information with each other based on the representative collection information. In this case, the augmented status information regarding the first robot 101 has the same meaning as the augmented status information regarding the add-on device 701 mounted on the first robot 101 and the augmented status information regarding the first robot assembly 1100 including the first robot 101 and the add-on device 701.

During the process of merging the robot status information and the device status information with each other, the remaining collected information not determined to be representative collection information is not utilized.

As an example, when the first collection information of the robot status information is determined to be representative collection information, the integrated control apparatus 300 for multiple types of robots may generate augmented status information regarding the first robot 101 by merging the robot status information with the remaining information obtained excluding the second collection information from the device status information. The augmented status information regarding the first robot 101 includes the first collection information, but does not include the second collection information.

As another example, when the second collection information of the device status information is determined to be representative collection information, the integrated control apparatus 300 for multiple types of robots may generate augmented status information regarding the first robot 101 by merging the device status information with the remaining robot status information obtained by excluding the first collection information from the robot status information. The augmented status information regarding the first robot 101 does not include the first collection information, but includes the second collection information.

Meanwhile, when the first collection information and the second collection information do not overlap each other, the integrated control apparatus 300 for multiple types of robots does not perform the above-described procedure of determining representative collection information.

The integrated control apparatus 300 for multiple types of robots generates augmented status information regarding the first robot 101 by merging the robot status information and the device status information with each other based on the first collection information and the second collection information.

The augmented status information regarding the first robot 101 includes both the first collection information and the second collection information. Since there is no overlap in collected information, the exclusion of predetermined collection information does not occur in the process of merging the robot status information and the device status information with each other.

Meanwhile, when as a result of the determination of whether the add-on device 701 mounted on the first robot 101 is identified based on the identifier of the robot status information, the add-on device 701 mounted on the first robot 101 cannot be found, i.e., when there is no add-on device mounted on the first robot 101, the integrated control apparatus 300 for multiple types of robots generates augmented status information regarding the first robot 101 based solely on the robot status information. The augmented status information regarding the first robot 101 includes only the first collection information.

The integrated control apparatus 300 for multiple types of robots transmits augmented status information regarding the first robot 101 to the user device 400 and, as described above, provides a user environment for the integrated control apparatus 300 for multiple types of robots based on the augmented status information regarding the first robot 101.

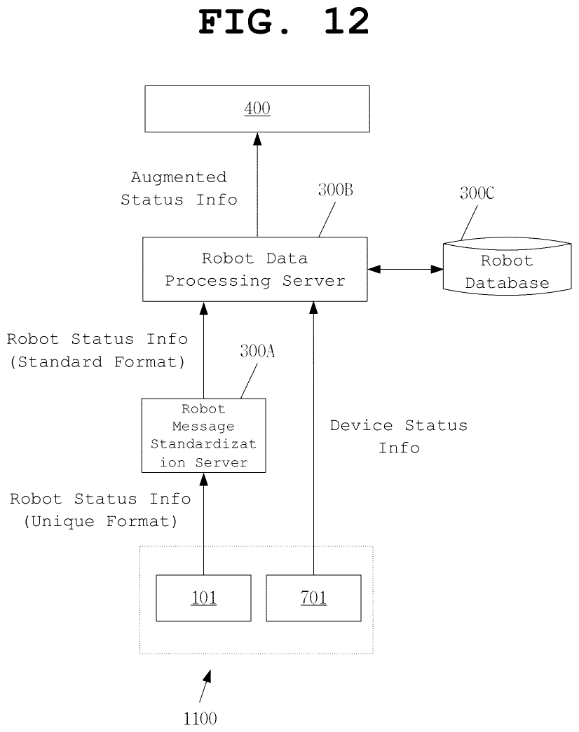

FIG. 12 is a diagram schematically showing the simultaneous performance of the augmentation and standardization of the robot status information of FIG. 11.

Referring to FIG. 12, the integrated control apparatus 300 for multiple types of robots simultaneously performs the augmentation and standardization of the robot status information.

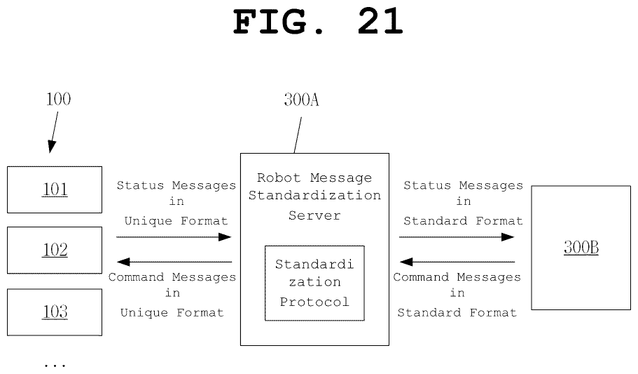

To this end, the integrated control apparatus 300 for multiple types of robots includes a robot message standardization server 300A, a robot data processing server 300B, and a robot database 300C. The detailed roles and operating methods of the servers and the database will be described later with reference to FIGS. 21 to 23.

The robot message standardization server 300A generates robot status information in a standard format by receiving robot status information in a unique format from the first robot 101 and then performing the standardization conversion of the robot status information, received from the first robot 101, into the standard format.

The multiple types of robots 100 are composed of different types of robots and, thus, are in a non-standardized state, so that there is required the standardization of the information to be transmitted by the multiple types of robots 100. However, since the add-on device 700 is assumed to be provided in a standardized configuration, there is not required information or data processing for standardization.

Accordingly, there is not required a standardization process for the device status information to be transmitted by the add-on device 701 mounted on the first robot 101. The robot message standardization server 300A receives status information only from the first robot 101.

The robot data processing server 300B generates augmented status information by processing robot status information and device status information. The robot data processing server 300B receives standardization-converted robot status information in a standard format from the robot message standardization server 300A, and also receives device status information from the add-on device 701 mounted on the first robot 101. The robot data processing server 300B generates the augmented status information described with reference to FIG. 11. The robot data processing server 300B generates augmented status information regarding the first robot 101 by merging the standardization-converted robot status information and the device status information with each other. When generating the augmented status information regarding the first robot 101, the robot data processing server 300B may refer to the preset priorities stored in the robot database 300C. The robot data processing server 300B transmits the augmented status information regarding the first robot 101 to the user device 400, and provides a user environment based on the augmented status information, as described above.

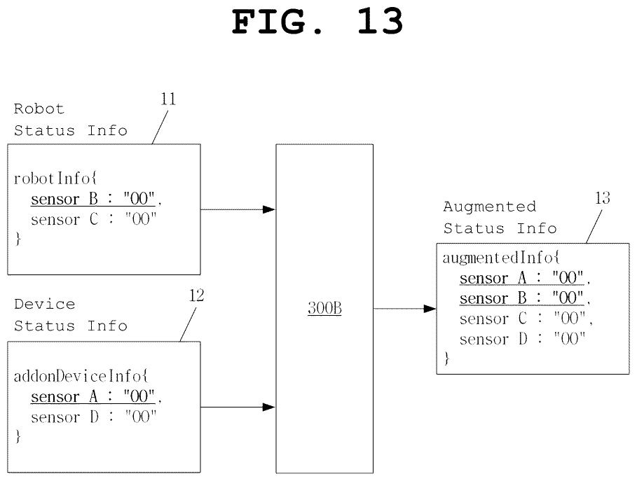

FIGS. 13 to 15 are diagrams schematically showing various examples of generating augmented status information by processing robot status information.

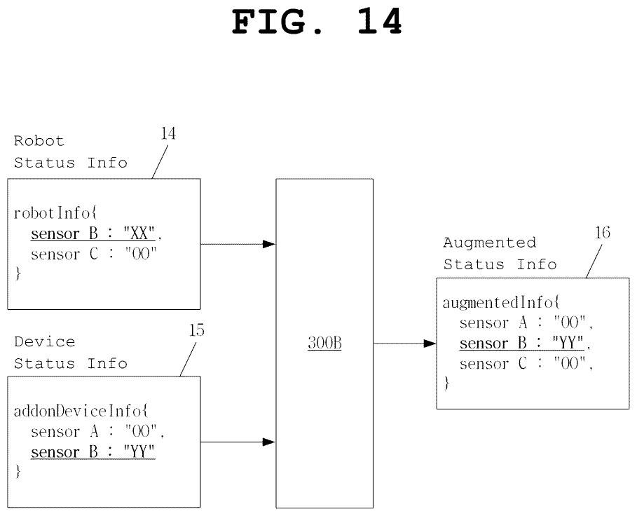

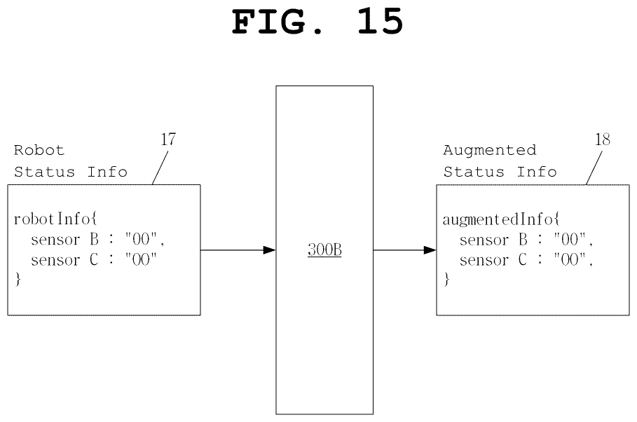

FIGS. 13 and 14 show examples of a case where there is an add-on device 700 mounted on a predetermined robot 100, and FIG. 15 shows an example of a case where there is no add-on device 700.

Furthermore, FIG. 13 shows an example in which there is no overlap between first collection information inside robot status information 11 and second collection information inside device status information 12. FIG. 14 shows an example in which there is an overlap between the first collection information inside the robot status information 11 and the second collection information inside the device status information 12.

Referring to FIG. 13, the robot status information 11 includes the information collected by each of sensors B and C included in the robot 100, and the device status information 12 includes the information collected by each of sensors A and D included in the add-on device 700 mounted on the robot 100.

Sensors A to D are different types of sensors. For example, sensor A is a distance sensor, sensor B is a collision detection sensor, sensor C is a lidar sensor, and sensor D is an image sensor. Accordingly, there is no overlap between various types of collected information inside the robot status information 11 and various types of collected information inside the device status information 12.

In this case, the robot data processing server 300B generates augmented status information 13 regarding the predetermined robot 100 by merging the robot status information 11 and the device status information 12 with each other without performing the above-described procedure of determining representative collection information.

By the above merging, in the example shown in FIG. 13, it can be seen that the augmented status information 13 includes both information collected by the sensors included in the robot 100 and information collected by the sensors included in the add-on device 700.

Referring to FIG. 14, robot status information 14 includes the information collected by sensors B and C included in the robot 100, and device status information 15 includes the information collected by sensors A and B included in the add-on device 700 mounted on the robot 100.

Since the robot 100 and the add-on device 700 contain the same type of sensor B, an overlap occurs between the information collected by sensor B inside the robot status information 14 and the information collected by sensor B inside the device status information 15.

The information collected by sensor B in the robot status information 14 contains the value “XX,” and the information collected by Sensor B inside the device status information 15 contains the value “YY.” Accordingly, the robot data processing server 300B needs to perform the above-described procedure of determining representative collection information and generate augmented status information 16 in the predetermined robot 100 by using only one of the values “XX” and “YY.”

In the example shown in FIG. 14, it can be seen that the robot data processing server 300B determined the information collected by sensor B inside the device status information 15 to be representative collection information and generated augmented status information 16 based on the value “YY” of the representative collection information. The robot data processing server 300B merged the robot status information 14 and device status information 15, but did not utilize the information collected by sensor B inside the robot status information 14 that was not determined to be representative collection information.

The robot data processing server 300B performs the determination of whether there is an overlap not only on the information collected by sensor B inside the robot status information 14, but also on the remaining collected information, i.e., the information collected by sensor C.

As a result, it can be seen that the augmented status information 16 includes other collected information that does not correspond to overlapping collected information, i.e., the information collected by sensor C included in the robot 100 and the information collected by sensor A included in the add-on device 700.

Referring to FIG. 15, when there is no add-on device mounted on the predetermined robot 100, the robot data processing server 300B cannot find the add-on device and generates augmented status information 18 by using only the robot status information 17.

Accordingly, the augmented status information 18 includes only the information collected by sensor B and sensor C included in the robot 100.

Although not explicitly shown in FIGS. 13 to 15, the robot data processing server 300B may primarily simply merge robot status information and device status information. Thereafter, the robot data processing server 300B may determine whether there is any overlap between various types of collected information within the status information obtained through the simple merging and perform required processing to secondarily generate augmented status information. For example, the status information generated through the simple merging may has a form including both a “robotInfo” object and an “addonDeviceInfo” object, but is not limited thereto.

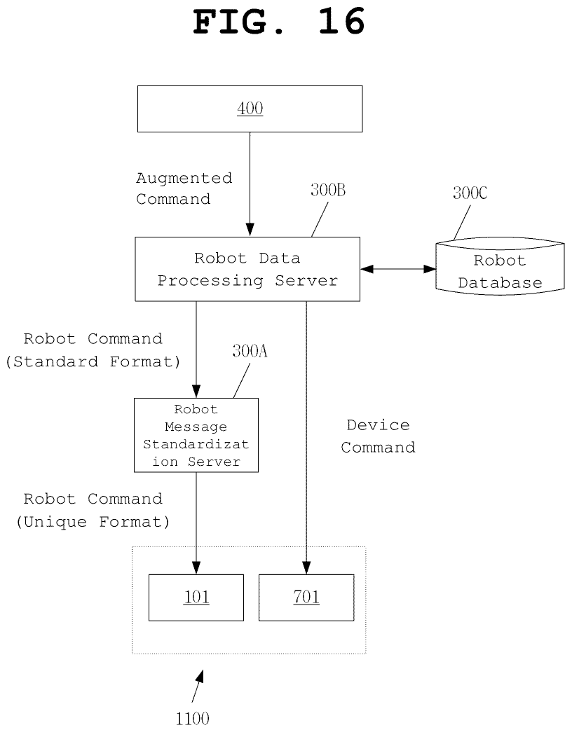

FIG. 16 is a diagram schematically showing a process in which an integrated control apparatus for multiple types of robots according to some embodiments of the inventive concept processes an augmented robot command by using an add-on device. For ease of description, the case of generating a robot command or device command based on an augmented command regarding a first robot 101 will be described as a representative example.

Referring to FIG. 16, the integrated control apparatus 300 for multiple types of robots provides a user environment for the integrated control apparatus 300 for multiple types of robots based on augmented command information regarding the first robot 101.

A user may input an augmented command regarding the first robot 101 by using the user environment, and the integrated control apparatus 300 for multiple types of robots may receive the augmented command regarding the first robot 101 from the user device 400. In this case, the augmented command regarding the first robot 101 has the same meaning as an augmented command regarding an add-on device 701 mounted on the first robot 101 and an augmented command regarding a first robot assembly 1100 including the first robot 101 and the add-on device 701.

The integrated control apparatus 300 for multiple types of robots identifies the first function command of the augmented command regarding the first robot 101 received from a user. The first function command of the augmented command represents a command regarding a function that the first robot assembly 1100 can execute using a predetermined output device inside the first robot 101 or the add-on device 701 mounted on the first robot 101. The augmented command may further include commands regarding various functions that can be executed using various output devices in addition to the above-described output device.

In addition, the integrated control apparatus 300 for multiple types of robots may identify the add-on device 701 mounted on the first robot 101 based on the identifier of the augmented command.

As described above, the augmented command may include the identifier of the first robot 101 or the identifier of the add-on device 701 mounted on the first robot 101.

The integrated control apparatus 300 for multiple types of robots analyzes the registration information of the first robot 101 and the registration information of the add-on device 701 mounted on the first robot 101. The registration information may include information about the output device that each of the robot 100 and the add-on device 700 includes or the function command that each of the robot 100 and the add-on device 700 can execute. The registration information may be stored in a robot database (not shown) inside the integrated control apparatus 300 for multiple types of robots.

The integrated control apparatus 300 for multiple types of robots determines whether the first robot 101 or the add-on device 701 mounted on the first robot 101 can execute the first function command based on the registration information of the first robot 101 and the add-on device 701 mounted on the first robot 101. The integrated control apparatus 300 for multiple types of robots determines whether the first robot 101 or the add-on device 701 mounted on the first robot 101 can execute various function commands within the augmented command.

When both the first robot 101 and the add-on device 701 mounted on the first robot 101 can execute the first function command, i.e., when there are multiple devices capable of executing the first function command inside the first robot assembly 1100, the integrated control apparatus 300 for multiple types of robots needs to perform an additional procedure required to address a problem of overlapping regarding the function command.

In some embodiments, the integrated control apparatus 300 for multiple types of robots may determine either the first robot 101 or the add-on device 701 mounted on the first robot 101 to be a representative device that will execute the first function command, and may not generate the commands to be described later for the remaining device not determined to be a representative device.

In some embodiments, priorities for determining a representative device may be preset and stored in a robot database (not shown) within the integrated control apparatus 300 for multiple types of robots. The priorities may be set on a per-user or per-robot (per-add-on device) basis. For example, a user may set priorities for all robots 100, for which he or she has authority, so that the robot 100 is determined to be a representative device or the add-on device 700 is determined to be a representative device. Alternatively, a user may set a priority for one of the robots 100, for which he or she has authority, so that the robot 100 is determined to be a representative device and set a priority for another robot 100 so that the add-on device 700 is determined to be a representative device. Alternatively, the priorities may be set for respective function commands.

In some embodiments, the integrated control apparatus 300 for multiple types of robots may determine one of the first robot 101 and the add-on device 701 mounted on the first robot 101 to be a representative device based on the priorities.

The integrated control apparatus 300 for multiple types of robots generates a robot command regarding the first robot 101 or device command regarding the add-on device 701 mounted on the first robot 101 to execute the first function command of the augmented command based on the result of the determination of the representative device.

During the process of generating the command, there are not generated commands for the remaining device not determined to be a representative device.

As an example, when the first robot 101 is determined to be a representative device, the integrated control apparatus 300 for multiple types of robots generates a robot command regarding the first robot 101, i.e., a command to cause the first robot 101 to execute the first function command, and does not generate a device command regarding the add-on device 701.

As another example, when the add-on device 701 mounted on the first robot 101, rather than the first robot 101, is determined to be a representative device, the integrated control apparatus 300 for multiple types of robots generates a device command regarding the add-on device 701, i.e., a command to cause the add-on device 701 to execute the first function command, and does not generate a robot command regarding the first robot 101.

Meanwhile, when there is no overlapping device capable of executing the first function command, the integrated control apparatus 300 for multiple types of robots does not perform the above-described procedure of determining a representative device.

The integrated control apparatus 300 for multiple types of robots generates only commands for one device capable of executing the first function command. For example, when the first robot 101 cannot execute the first function command and only the add-on device 701 can execute the first function command, the integrated control apparatus 300 for multiple types of robots generates a device command regarding the add-on device 701 mounted on the first robot 101 to execute the first function command of the augmented command. In contrast, when the add-on device 701 cannot execute the first function command and only the first robot 101 can execute the first function command, the integrated control apparatus 300 for multiple types of robots generates a robot command regarding the first robot 101 to execute the first function command of the augmented command.

Meanwhile, in the case where as a result of the identification of the add-on device 701 mounted on the first robot 101 based on the identifier of the augmented command, the add-on device 701 mounted on the first robot 101 cannot be found, i.e., there is no add-on device mounted on the first robot 101, the integrated control apparatus 300 for multiple types of robots generates a robot command regarding the first robot 101 to execute the first function command of the augmented command, unlike the case where the add-on device 701 mounted on the first robot 101 cannot execute the first function command.

The integrated control apparatus 300 for multiple types of robots transmits a generated command. When a robot command regarding the first robot 101 is generated, the robot command is transmitted to the first robot 121. In contrast, when a device command regarding the add-on device 701 mounted on the first robot 101 is generated, the device command is transmitted to the add-on device 701.

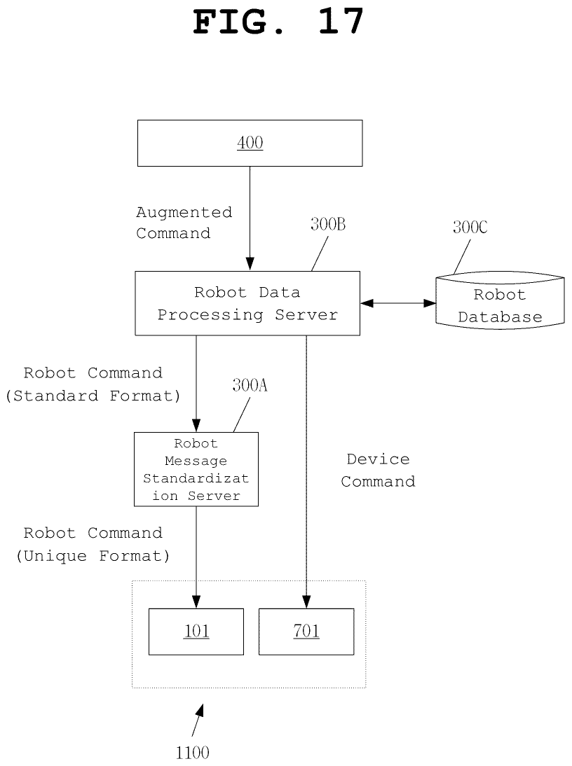

FIG. 17 is a diagram schematically showing the simultaneous performance of the processing and standardization of the augmented command of FIG. 16.

Referring to FIG. 17, the integrated control apparatus 300 for multiple types of robots simultaneously performs the processing and standardization of the augmented command.

The robot data processing server 300B provides a user environment based on augmented command information as described above, and receives an augmented command regarding the first robot 101 from the user device 400.

The robot data processing server 300B generates a robot command or device command by processing the augmented command. The robot data processing server 300B receives an augmented command regarding the first robot 101 from the user device 400. The robot data processing server 300B performs the segmentation of the augmented command described with reference to FIG. 16. The robot data processing server 300B generates a robot command regarding the first robot 101 or a device command regarding the add-on device 701 mounted on the first robot 101 to execute the augmented command. When generating the robot command regarding the first robot 101 or the device command regarding the add-on device 701, the robot data processing server 300B may refer to the registration information and preset priorities stored in the robot database 300C. When generating the robot command regarding the first robot 101, the robot data processing server 300B may generate a robot command in a standard format regarding the first robot 101.

The robot message standardization server 300A receives the robot command in the standard format regarding the first robot 101 from the robot data processing server 300B, and then performs the de-standardization of the robot command regarding the first robot 101 to generate a robot command in a unique format regarding the first robot 101.

As described with reference to FIG. 12, the multiple types of robots 100 are composed of different types of robots and, thus, are in a non-standardized state, so that there is required the de-standardization of a command to be transmitted to each robot 100. However, since the add-on device 700 is assumed to be provided in a standardized configuration, there is not required information or data processing for de-standardization.

Accordingly, there is not required a de-standardization process for a device command to be transmitted to the add-on device 701 mounted on the first robot 101. The robot message standardization server 300A receives only a robot command from the robot data processing server 300B.

The robot message standardization server 300A transmits the de-standardized robot command to the first robot 101. The robot data processing server 300B transmits a device command to the add-on device 701 without passage through the robot message standardization server 300A.

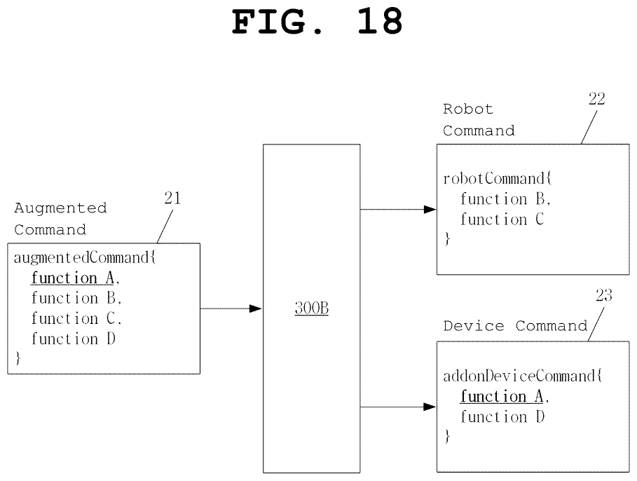

FIGS. 18 to 20 are diagrams schematically showing various examples of generating a robot command by processing an augmented command.

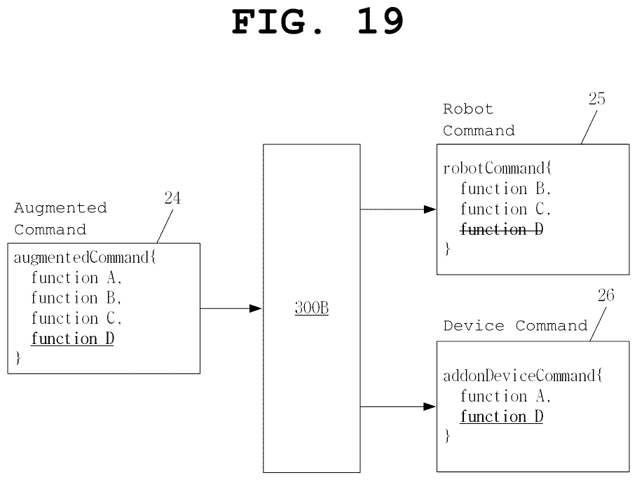

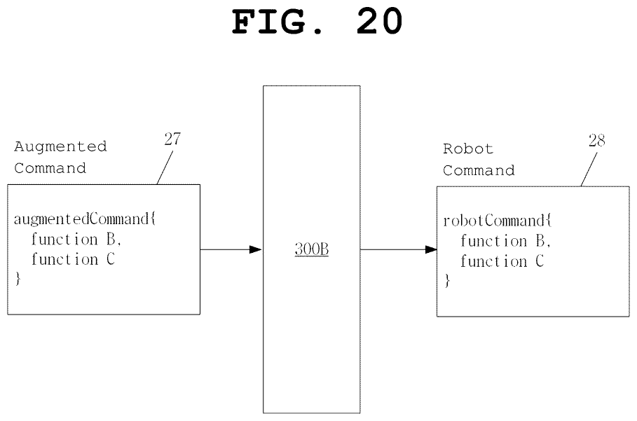

FIGS. 18 and 19 show examples of a case where there is an add-on device 700 mounted on a predetermined robot 100, and FIG. 20 shows an example of a case where there is no add-on device 700.

Furthermore, FIG. 18 shows an example in which there is no overlap between devices capable of executing a predetermined function command, and FIG. 19 shows an example in which there are overlapping devices capable of executing a predetermined function command

Referring to FIG. 18, an augmented command 21 regarding a predetermined robot 100 includes f function command A, function command B, function command C, and function command D.

Function command A may be executed using output device A, function command B may be executed using output device B, function command C may be executed using output device C, and function command D may be executed using output device D.

The robot data processing server 300B determines whether for each function command within the augmented command 21, the predetermined robot 100 or the add-on device 700 mounted on the predetermined robot 100 may execute the corresponding function command, as described above.

For ease of description, in the example shown in FIG. 18, there will be described only a determination process regarding function command A.

Based on the registration information stored in the robot database 300C, the robot data processing server 300B may determine that the robot 100 cannot execute function command A, but that the add-on device 700 can execute function command A. For example, function command A may require a transmitter capable of outputting RF signals. In the above case, the transmitter is contained only within the add-on device 700, so that the add-on device 700 can execute function command A

In this case, the robot processing server 300B generates a device command 23 regarding the add-on device 700 to execute function command A of the augmented command 21 without performing the above-described procedure of determining a representative device. A robot command 22 is not generated for function command A.

In the example shown in FIG. 18, it can be seen that the device command 23 includes a function command corresponding to function command A, but the robot command 22 does not include a function command corresponding to function command A.

It is assumed that other commands within the augmented command 21, i.e., function commands B and C, can be executed by the robot 100 and function command D can be executed by the add-on device 700.

The robot data processing server 300B may also perform the above-described process for other commands within the augmented command 21, ultimately generating the robot command 22 and the device command 23 as shown in FIG. 18.

According to the example shown in FIG. 18, function commands A and D included in the augmented command 21 are executed by the add-on device 700, and function commands B and C are executed by the robot 100.

Referring to FIG. 19, an augmented command 214 regarding a predetermined robot 100 includes function commands A, B, C, and D, like in FIG. 18.

For ease of description, in the example shown in FIG. 19, there will be described only a determination process regarding function command D.

The robot data processing server 300B may determine that both the robot 100 and the add-on device 700 can execute function command D based on the registration information stored in the robot database 300C. This corresponds to a case where there are overlapping devices capable of executing function command D.

For example, function command D may require a transmitter capable of outputting Bluetooth signals. In the above case, the transmitter may be included in each of the robot 100 and the add-on device 700, so that both the robot 100 and the add-on device 700 can execute function command D.

The robot data processing server 300B needs to perform the above-described procedure of determining a representative device and generate a command to execute function command D only for one device.

In the example shown in FIG. 19, the robot data processing server 300B determines the add-on device 700, not the robot 100, to be a representative device to execute function command D, and generates a device command 26 regarding the add-on device 700 to execute function command D. The robot data processing server 300B does not generate a robot command 25 for function command D.

It is assumed that the other commands within the augmented command 24, i.e., function commands B and C, may be executed by the robot 100 and function command A may be executed by the add-on device 700.

The robot data processing server 300B may also perform the above-described process for other commands within the augmented command 24, ultimately generating a robot command 25 and a device command 26, as shown in FIG. 19.

According to the example shown in FIG. 19, function commands A and D included in the augmented command 24 are executed by the add-on device 700, and function commands B and C are executed by the robot 100.

Referring to FIG. 20, when there is no add-on device mounted on a predetermined robot 100, the robot data processing server 300B cannot find the add-on device and, thus, generates a robot command 28 to cause the robot 100 to execute all function commands contained within an augmented command 27.

Accordingly, all functional commands included in the augmented command 27, i.e., function command B and function command C, are executed solely by the robot 100.

Although not explicitly shown in FIGS. 18 to 20, the robot data processing server 300B primarily simply segments an augmented command based on registration information to generate robot and device commands. Thereafter, the robot data processing server 300B determines whether the robot and add-on device execute the commands, obtained by the simple segmentation, in an overlapping manner and performs required processing to secondarily modify the robot and device commands. For example, the robot and device commands generated through the simple segmentation may include the same functional commands, but are not limited thereto.

So far, the augmentation of robot status information and a robot command using an add-on device has been described with reference to FIGS. 7 to 20. Message standardization for the integrated control apparatus 300 for multiple types of robots will be described below.

As described above, the integrated control apparatus 300 for multiple types of robots performs the standardization and processing of information and/or data transmitted and received to and from the multiple types of robots 100.

The integrated control apparatus 300 for multiple types of robots transmits and receives messages to and from the multiple types of robots 100. Since the message format of the multiple types of robots 100 differ, the standardization of robot messages is required for the integrated data processing of the integrated control apparatus 300 for multiple types of robots.

The robot message standardization server 300A transmits and receives status and command messages to and from the multiple types of robots 100, and performs the standardization of the status messages and the command messages. The robot message standardization server 300A receives status messages in unique format from the multiple types of robots 100, and converts the status messages in the unique format into status messages in a standard format. This sequential conversion will be referred to as “standardization conversion” hereinafter. Furthermore, the robot message standardization server 300A receives command messages in the standard format from the robot data processing server 300B, and converts the command messages in in the standard format into command messages in the unique format. This sequential conversion will be referred to as “de-standardization conversion” hereinafter as the concept opposed to that of “standardization conversion.”

A status message in a unique format includes robot status information in the unique format described above. A status message in a standard format includes robot status information in the standard format described above. A command message in a standard format includes robot commands in the standard format described above, and a command message in a unique format includes robot commands in the unique format described above. The standardization conversion includes the standardization conversion of robot status information in the unique format. The de-standardization conversion includes the de-standardization conversion of a robot command in the standard format.

The robot data processing server 300B is connected to the robot message standardization server 300A and the robot database 300C. The robot data processing server 300B may process the data within various messages transmitted and received to and from the robot message standardization server 300A or the data within various pieces of information transmitted and received to and from the user devices 400. The robot data processing server 300B may process the data received from the robot message standardization server 300A or the robot database 300C in response to the requests received from the user devices 400, and may transmit the processed data to the user devices 400. The robot data processing server 300B may generate augmented robot status information corresponding to status messages in the standard format based on the status messages in the standard format received from the robot message standardization server 300A. Furthermore, the robot data processing server 300B may generate command messages in the standard format corresponding to an augmented command based on the augmented command received from the user devices 400.

The robot data processing server 300B may receive status messages in the standard format from the robot message standardization server 300A. The robot data processing server 300B may transmit command messages in the standard format to the robot message standardization server 300A. The robot data processing server 300B may transmit augmented status information to the user devices 400. The robot data processing server 300B may receive an augmented command from the user devices 400.

The robot data processing server 300B may perform data purification intended to remove data errors, omissions, inconsistencies, and overlaps, and/or the like inside the messages transmitted to and received from the robot message standardization server 300A.

The robot data processing server 300B may store data processing results in the robot database 300C. The robot data processing server 300B may query, modify, or delete the data stored in the robot database 300C, or may store new data in the robot database 300C.

The robot database 300C stores various types of data or information within the integrated control apparatus 300 for multiple types of robots. The robot database 300C may store various types of information, such as augmented status information, robot status information, device status information, augmented commands, robot commands, device commands, and alarm information, received from the robot data processing server 300B. The robot database 300C may store status and command messages in a raw state transmitted and received between the robots 100 and the robot message standardization server 300A without passage through data processing by the robot data processing server 300B. The robot database 300C may store the above-described registration information, various types of priority information, and/or the like. For example, the robot database 300C may be implemented to include one or more types of databases among a hierarchical database, a network database, and a relational database, but is not limited thereto. The robot database 300C may be implemented to include one or more database management systems.

FIG. 21 is a diagram schematically showing message conversion using a standardization protocol according to some embodiments of the inventive concept.

Referring to FIG. 21, a robot message standardization server 300A performs the standardization and de-standardization of messages between multiple types of robots 100 and a robot data processing server 300B by using standardization protocols.

The robot message standardization server 300A transmits and receives status and command messages in unique format to and from the multiple types of robots 100.

In this case, the “unique format” refers to the message format, structure, layout, and/or the like of a corresponding robot, which are uniquely distinguished from those of other robots in the transmission and reception of status and command messages.

In addition, the status message is a message transmitted by the robot 100 to the control system for the status monitoring function of the robot 100. The status message may include various types of status data, such as network connection status data, robot status data, and battery level data. The command message is a message transmitted by the control system to the robot 100 for the remote control function of the robot 100. The command message may include various types of command data, such as movement commands, destination location commands, and emergency stop commands. Hereinafter, the simple term “message” refers to a status message, a command message, or a combination thereof.

For example, in the case of a first-type robot 100 manufactured by a first manufacturer, the robot message standardization server 300A transmits and receives status and command messages in a first unique format to and from the first-type robot 100. In the case of a second-type robot 100 manufactured by a second manufacturer, the robot message standardization server 300A transmits and receives status and command messages in a second unique format to and from the second-type robot 100. When the first and second manufacturers are different from each other, the first and second unique format may also differ from each other. Accordingly, despite having substantially the same meaning, the expressions of data within status messages or command messages may differ from each other.

For example, the keys of the data used to convey that the current operational status of the robot is a driving status may differ, as in the case where they are “state” and “moveState,” and the values thereof may differ, as in the case where they are “move” and “moving.”

Furthermore, even when the manufacturers of the first- and second-type robots 100 are the same, the same situation may arise due to a difference in version, system update, or software upgrade.

The robot message standardization server 300A performs message standardization and de-standardization by using a standardization protocol for various purposes, such as the maintenance of data consistency, the improvement of data quality, efficient data management, and clear communication during the integrated control of the multiple types of robots 100. When direct code modification is applied to message standardization and de-standardization, lots of labor and time are required. In contrast, when a standardization protocol is utilized, message conversion may without code be mechanically performed modification, and thus this is more efficient.

The standardization protocol may include various rules for the conversion of status messages in a unique format into status messages in a standard format and the conversion of command messages in the standard format into command messages in the unique format.

In some embodiments, the standardization protocol may include a plurality of standardization protocols distinguished by the types of robots 100. The robot message standardization server 300A may select a standardization protocol corresponding to a specific robot 100 from among the plurality of standardization protocols based on data such as a robot identifier, robot type data, a standardization protocol identifier, and/or the like within a message in a unique format received from the specific robot 100 or a message in a standard format received from the robot data processing server 300B and set to the specific robot 100 for its recipient.

In some embodiments, the standardization protocol may include a mapping between the data contained in a message in a unique format and the data contained in a message in a standard format.

In some embodiments, data in the messages transmitted and received between the robots 100 and the integrated control apparatus 300 for multiple types of robots may be implemented in a key-value pair structure.

Accordingly, the standardization protocol may include a mapping between the keys and values of specific data within messages in a unique format and the keys and values of specific data within messages in a standard format.

More specifically, the standardization protocol may include a mapping between the source keys and source values of status messages in a unique format and the target keys and target values of status messages in a standard format. In this case, the “source” represents the original value before standardization, and the “target” represents the value after standardization.

Furthermore, the standardization protocol may include a mapping between the source keys and source values of command messages in a standard format and the target keys and target values of command messages in a unique format. In this case, the “source” represents the original value before de-standardization, and the target represents the value after de-standardization.

When the integrated control apparatus 300 for multiple types of robots receives status messages from one or more robots 100, the robot message standardization server 300A receives status messages in unique format from the one or more robots 100, converts the status messages in the unique format into status messages in a standard format according to the standardization protocol, and then transmits the status messages in the standard format to the robot data processing server 300B.

In contrast, when the integrated control apparatus 300 for multiple types of robots transmits command messages to one or more robots 100, the robot message standardization server 300A receives command messages in the standard format from the robot data processing server 300B, converts the command message in the standard format into command messages in unique format according to the standardization protocol, and then transmits the command messages in the unique format to the one or more robots 100.

Thus, the robot data processing server 300B may transmit and receive status and command messages in a standard format to and from the robot message standardization server 300A, rather than directly transmitting and receiving status and command messages in the format of the respective types of robots 100 to and from the multiple types of robots 100.

Meanwhile, by separating the robot message standardization server 300A and the robot data processing server 300B from each other, the performance of each of the servers may be optimized and each of the servers may be independently expanded as needed. Furthermore, when maintenance, such as the update of the standardization protocol, is required, the maintenance may be more easily performed on the robot message standardization server 300A without affecting the robot data processing server 300B.

For example, the standardization protocol is written using the Javascript Object Notation (JSON) format. However, the standardization protocol is not limited to the JSON format, and may be written using various data exchange format, such as Extensible Markup Language (XML) or Comma Separated Values (CSV), which are well known in the art to which the inventive concept pertains.

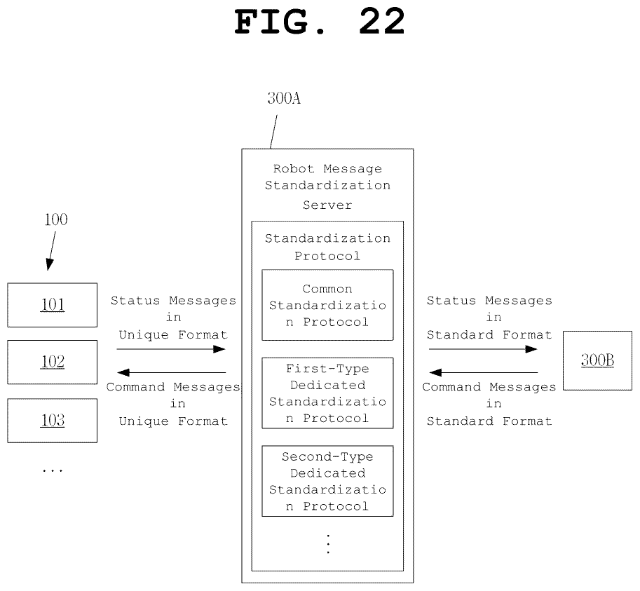

FIG. 22 is a diagram schematically showing message conversion using a common standardization protocol and a dedicated standardization protocol according to some embodiments of the inventive concept.

Referring to FIG. 22, the robot message standardization server 300A performs the standardization and de-standardization of messages between multiple types of robots 100 and a robot data processing server 300B by using a standardization protocol including a common standardization protocol and multiple dedicated standardization protocols.

The standardization protocol includes the common standardization protocol for the standardization of common states or commands and the multiple dedicated standardization protocols for the standardization of dedicated states or commands for the multiple types of robots 100. For example, the types of robots may be classified according to their function, but are not limited thereto.

For example, the standardization protocol may include dedicated standardization protocols for various types of robots, such as a dedicated standardization protocol for industrial robots, a dedicated standardization protocol for collaborative robots, a dedicated standardization protocol for logistics robots, a dedicated standardization protocol for cleaning robots, a dedicated standardization protocol for serving robots, and a dedicated standardization protocol for delivery robots.

For example, when there are provided two types of robots (a delivery robot and a cleaning robot) that perform different functions, the standardization protocol may include, in addition to a common standardization protocol, a first-type dedicated standardization protocol for the standardization of dedicated statuses or commands of a first type of robot (the delivery robot) and a second-type dedicated standardization protocol for the standardization of dedicated statuses or commands of a second type of robot (the cleaning robot).

The common standardization protocol is intended for the standardization of common statues or commands among the multiple types of robots 100. In this case, the common statuses or commands are related to common performances or functions of the respective types of the multiple types of robots 100. For example, the common statuses or commands may include, but are not limited to, one or more of the following: robot identifiers, network connection statuses, robot statuses, emergency stop, charging statuses, battery levels, destination locations, origin locations, remaining times to destinations, remaining distances to destinations, robot locations, error occurrence information, and the like.

In some embodiments, the common standardization protocol may include a mapping between data regarding common statuses or commands contained in messages in a unique format and data regarding common statuses or commands contained in messages in a standard format. The common standardization protocol may include a mapping between source keys and values regarding common statuses in status messages in a unique format and target keys and values regarding common statuses in status messages in a standard format. The common standardization protocol may include a mapping between source keys and values regarding common commands in command messages in a standard format and target keys and values regarding common commands in command messages in a unique format.

The dedicated standardization protocol is intended for the standardization of dedicated statuses or commands for the various types of robots 100. In this case, the dedicated statuses or commands are related to additional performances or functions for the respective types of the multiple types of robots 100. For example, the dedicated statuses or commands may include, but are not limited to, one or more of the following: cleaning mode, the presence or absence of guidance schedule setting, and the presence or absence of delivery item loading.

In some embodiments, the dedicated standardization protocol may include a mapping between data regarding dedicated statuses or commands contained in messages in a unique format and data regarding dedicated statuses or commands contained in messages in a standard format. The dedicated standardization protocol may include a mapping between source keys and values for dedicated statuses in status messages in a unique format and target keys and values for dedicated statuses in status messages in a standard format. The dedicated standardization protocol may include a mapping between source keys and values for dedicated commands in command messages in a standard format and target keys and values for dedicated commands in command messages in a unique format.

For example, when a delivery robot and a cleaning robot performing different functions are introduced into a single site 10, status data such as robot identifiers, network connection statuses, and robot statuses may be related to common statuses. Status data such as whether a delivery target item has been loaded may be related to a dedicated status of the delivery robot, and status data such as the cleaning mode may be related to a dedicated status of the cleaning robot.

In some embodiments, the robot message standardization server 300A may select a dedicated standardization protocol corresponding to the type of a specific robot 100 from among multiple dedicated standardization protocols based on data such as a robot identifier, robot type data, and/or a standardization protocol identifier within a message in a unique format received from the specific robot 100 or a message in a standard format received from a robot data processing server 300B and set to the specific robot 100 for its recipient.

When the integrated control apparatus 300 for multiple types of robots receives status messages from one or more first-type robots 100, the robot message standardization server 300A receives status messages in the unique format of the first-type robots 100 from one or more first-type robots 100, converts the status messages in the unique format of the first-type robots 100 into status messages in the standard format of the first-type robots 100 according to the standardization protocol, and then transmits the status messages in the standard format of the first-type robots 100 to the robot data processing server 300B.

In this case, the robot message standardization server 300A performs standardization conversion for common statuses within the status messages in the unique format of the first-type robots 100 by using a common standardization protocol, and performs standardization conversion for dedicated statuses within the status messages in the unique format of the first-type robots 100 by using a first-type dedicated standardization protocol.

In contrast, when the integrated control apparatus 300 for multiple types of robots transmits command messages to one or more first-type robots 100, the robot message standardization server 300A receives command messages in the first-type standard format from the robot data processing server 300B, converts the command messages in the first-type standard format into command messages in the unique format of the first-type robots 100 according to the standardization protocol, and then transmits the command messages in the unique format of the first-type robots 100 to the first-type robots 100.

In this case, the robot message standardization server 300A performs de-standardization conversion for common commands within the command messages in the first-type standard format by using a common standardization protocol, and performs de-standardization conversion for dedicated commands within the status messages in the first-type standard format by using a first-type dedicated standardization protocol.

When the integrated control apparatus 300 for multiple types of robots receives status messages from one or more second-type robots 100, the robot message standardization server 300A receives status messages in the unique format of the second-type robots 100 from the second-type robots 100, converts the status messages in the unique format of the second-type robots 100 into status messages in the second-type standard format according to the standardization protocol, and then transmits the status messages in the second-type standard format to the robot data processing server 300B.

The standardization conversion using the common standardization protocol and the second-type dedicated standardization protocol for status messages in the unique format of the second-type robots 100 is substantially the same as described above for the status messages in the unique format of the first-type robots 100.

In contrast, when the integrated control apparatus 300 for multiple types of robots transmits command messages to one or more second-type robots 100, the robot message standardization server 300A receives command messages in the second-type standard format from the robot data processing server 300B, converts the command messages om the second-type standard format into command messages in the unique format of the second-type robots 100 according to the standardization protocol, and then transmits the command messages in the unique format of the second-type robots 100 to the second-type robot.

The de-standardization conversion using the common standardization protocol and the second-type dedicated standardization protocol for command messages in the second-type standard format is substantially the same as described above for the command messages in the first-type standard format.

In some embodiments, standard status messages may include multiple different types of standard status messages for the respective types of robots, and standard command messages may include multiple different types of standard command messages for the respective types of robots. For example, the standard status messages may include a first type of standard status message and a second type of standard status message. Furthermore, the standard command messages may include a first type of standard command message and a second type of standard command message. In the case where robot types are classified according to their function, even when the unique format of the messages differ for various reasons and when two or more robots 100 have the same functional (for example, when they are all serving robots having the same functional), the standard status messages and standard command messages of the two or more robots 100 have the same format.

The robot message standardization server 300A utilizes a standardization protocol including a common standardization protocol and multiple dedicated standardization protocols, thus the more efficient standardization of messages from enabling robots having various functions and also increasing the flexibility of message standardization and de-standardization conversion. The robot message standardization server 300A reduces unnecessary computing resource consumption by using only dedicated standardization protocols corresponding to the types of robots 100 introduced into the site 10. Furthermore, when maintenance, such as the update of the standardization protocol, is required, only the dedicated standardization protocol may be updated without affecting the common standardization protocol, or conversely, only the common standardization protocol may be updated without affecting the dedicated standardization protocols. Furthermore, when a new type of robot is added to the control targets, the standardization protocol may be updated more easily by adding a dedicated standardization protocol for the corresponding type of robot.

Although not explicitly shown, the robot data processing server 300B may provide a user interfaces to the user device 400 based on a message in the standard format. The robot data processing server 300B may provide a user interface corresponding to data regarding statuses or commands within the message in the standard format. For example, the user interface may include a visual means corresponding to keys or values within the message in the standard format.

The robot data processing server 300B may provide a different type of user interface based on a message in the standard format of each type of robot. A user interface for each robot may include a common user interface portion that is common regardless of the type of robot and a dedicated user interface portion that differs for each type of robot.

The robot data processing server 300B may provide the first-type robot with a user interface including a common user interface portion and a first-type dedicated user interface portion. The robot data processing server 300B may provide the second-type robot with a user interface including a common user interface portion and a second-type dedicated user interface portion.

The robot data processing server 300B may provide the user device 400 of the first-type robot 100 with a common user interface portion, corresponding to a common state or command, and a first-type dedicated user interface portion, corresponding to a dedicated state or command of the first-type robot 100, based on a message in a first type of standard format.

The robot data processing server 300B may provide the user device 400 of the second-type robot 100 with a common user interface portion, corresponding to a common state or command, and a second-type dedicated user interface portion, corresponding to a dedicated state or command of the second-type robot 100, based on a message in a second type of standard format.

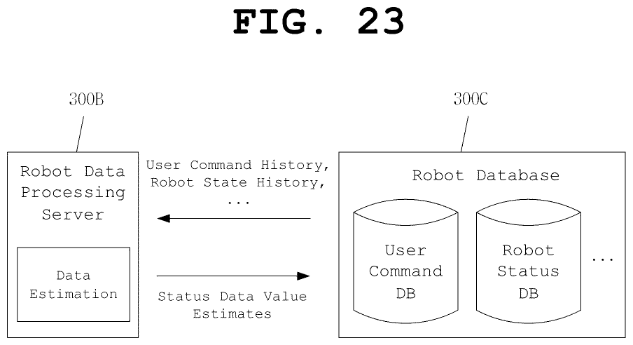

FIG. 23 is a diagram schematically showing estimating missing status data by using a robot database according to some embodiments of the inventive concept.

Referring to FIG. 23, a robot data processing server 300B estimates the values of one or more pieces of missing status data within a status message in a standard format of the one or more robots 100 received from the robot message standardization server 300A when there are the one or more pieces of missing status data within the status message.

The robot data processing server 300B may utilize data or information stored in a robot database 300C to estimate the values of the one or more pieces of missing status data. For example, the robot data processing server 300B may estimate the values of the one or more pieces of missing status data based on a user command history, a robot status history, or a combination thereof stored in the robot database 300C.

For example, the user command history may include records and change details of various types of user command data transmitted by the integrated control apparatus 300 for multiple types of robots to the robots 100, such as robot identifiers, work (or task) execution commands, work stop commands, pause commands, operation mode setting commands, movement commands, starting locations, destination locations, charging commands, move-to-standby location commands, emergency stop commands, map update commands, floor movement (boarding an elevator) commands, command transmission times (timestamps), and/or the like.

For example, the robot status history may include records and change details of various types of robot status data received from the robots 100 by the integrated control apparatus 300 for multiple types of robots, such as the robot identifiers, network connection statuses, robot statuses, emergency stop statuses, charging statuses, battery levels, starting locations, destination locations, remaining times to destinations, remaining distances to destinations, robot locations, error occurrence data, status reception times (timestamps), and/or the like.

In some embodiments, the robot database 300C may include a plurality of databases each storing various types of information, such as robot status information, user command information, alarm information, and/or the like. For example, the robot database 300C may include, but is not limited to, a robot status database for storing robot status information, a user command database for storing user command information, and an alarm database for storing alarm information.

In some embodiments, the robot data processing server 300B may estimate the value of first status data out of the one or more pieces of missing status data based on the data history stored in the robot database 300C. For example, when the “robot status” is missing from a status message in the standard format of the robot 100, the robot data processing server 300B may refer to the user command history of the robot 100 stored in the user command database by using the “robot identifier.” Furthermore, the robot data processing server 300B may estimate the value of the “robot status” missing from the status message in the standard format based on the records and change details of data transmitted by the integrated control apparatus 300 for multiple types of robots to the robots 100, such as work (or task) execution commands, work stop commands, pause commands, operation mode setting commands, movement commands, move-to-standby location commands, emergency stop commands, and/or the like. For example, when the command transmitted by the integrated control apparatus 300 for multiple types of robots to the robot 100 at the closest point in time to the present is a movement command to move to a specific destination, the robot data processing server 300B may estimate the value of the “robot status” as “moving.”

In some embodiments, the robot data processing server 300B may perform the above estimation in such a manner as to replace the value of second status data out of the one or more pieces of missing status data with the one or more values of the data history stored in the robot database 300C. For example, when the “starting location” and the “destination location” are missing from the status message in the standard format of the robot 100, the robot data processing server 300B may refer to the user command history of the robot 100 stored in the user command database by using the “robot identifier.” Furthermore, the robot data processing server 300B may replace the values of the “destination position” and “starting position” missing from the status message in the standard format with the “starting location” and “destination location” values transmitted together with a movement command by the integrated control apparatus 300 for multiple types of robots to the robot 100 at the closest point in time to the present. Even in the case where the “starting location” and the “destination location” are missing from the status message transmitted by a specific robot 100 to the integrated control apparatus 300 for multiple types of robots, when the robot 100 is in the state of operating normally, it will move from the starting location, commanded by the integrated control apparatus 300 for multiple types of robots, toward the destination location. Accordingly, it may be possible to replace the values of the “destination location” and “starting location” missing from the status message in the standard format with the values of the “starting location” and “destination location” transmitted together with the movement command by the integrated control apparatus 300 for multiple types of robots to the robot 100.

In some embodiments, the robot data processing server 300B may perform the above estimation in such a manner as to compute the value of third status data out of the one or more pieces of missing status data based on one or more values of the data history stored in the robot database 300C. For example, when the “remaining distance to destination” or “remaining time to destination” is missing from a status message in the standard format of the robot 100, the robot data processing server 300B may refer to the robot status history of the robot 100 stored in the robot status database by using the “robot identifier.” Furthermore, the robot data processing server 300B may compute the value of the “remaining distance to destination” missing from the status message in the standard format based on the values of the “robot location” and the “destination location” received at the closet point in time to the present from the robot 100 by the integrated control apparatus 300 for multiple types of robots. The robot data processing server 300B may compute the moving speed of the robot based on the change details of the “robot location” stored in the robot status database, and may also compute the value of the “time remaining to destination” missing from the status message in the standard format based on the moving speed of the robot and the value the “remaining distance to destination”.

In some embodiments, the robot data processing server 300B may perform the above estimation on some types of status data within status messages in the standard format of one or more robots 100. As described above, the status messages in the standard format may include common statuses related to the common performances or functions of multiple types of robots 100, and dedicated statuses related to additional performances or functions for each type of the multiple types of robots 100. For example, the robot data processing server 300B may perform the above estimation when one or more pieces of status data are missing from the common statuses. The integrated control apparatus 300 for multiple types of robots is intended to provide a consistent and unified user interface to the user devices 400 despite the differences in messages in the unique format of the multiple types of robots 100. The reason for this is that in this regard, the importance of preventing the omission of data related to the common statuses of the multiple types of robots 100 is relatively high.

In some embodiments, the robot data processing server 300B may perform the above estimation on all types of status data within status messages in the standard format of the one or more robots 100.

After completing the estimation, the robot data processing server 300B may store status data value estimates in the robot database 300C.

The integrated control apparatus 300 for multiple types of robots performs the standardization conversion of status and command messages in the unique format of the robot 100 by using a standardized protocol, and provides a user interface in association with the status and command messages in a standard format obtained through the conversion. Therefore, even when the multiple types of robots 100 introduced into the site 10 are from different manufacturers, a consistent and unified user interface may be provided to the user devices 400.

An integrated control method for multiple types of robots according to another embodiment of the inventive concept will be described below. For ease of description, detailed descriptions identical to those described with reference to FIGS. 1 to 23 will be omitted.

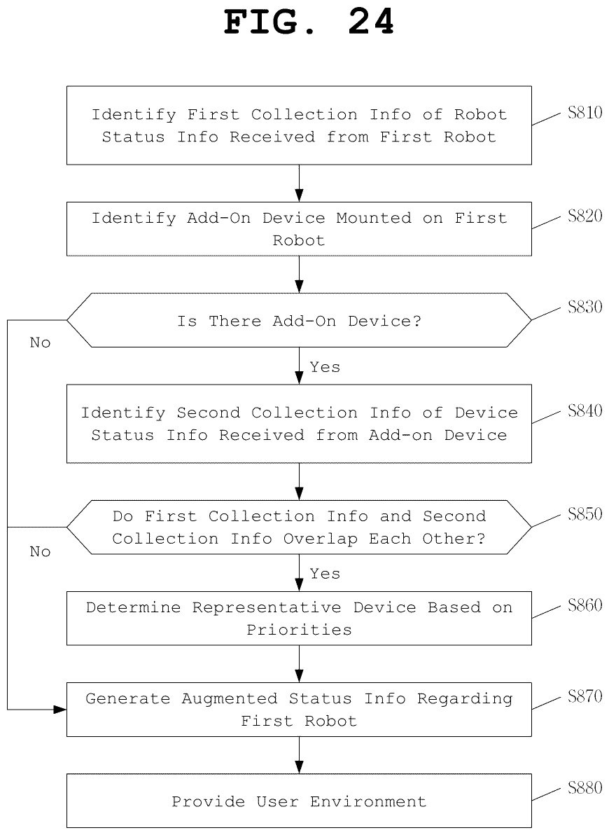

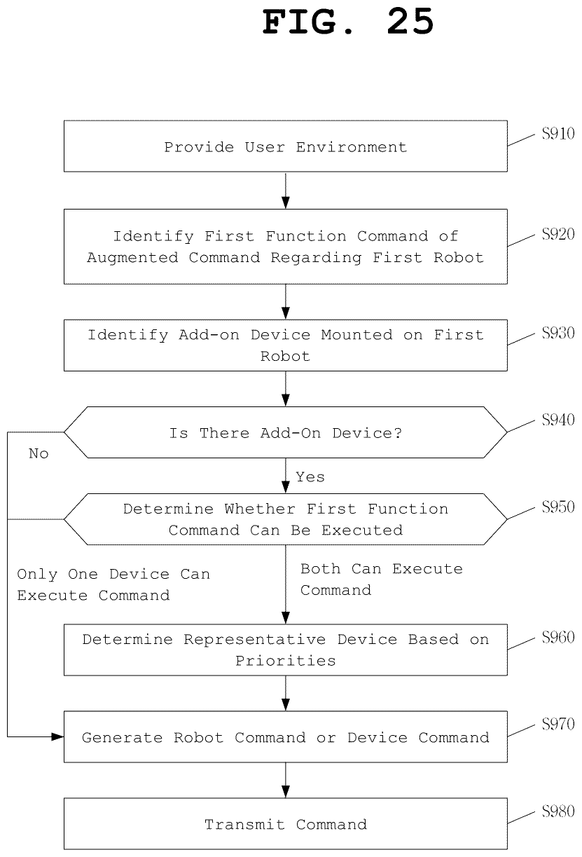

An integrated control method for multiple types of robots described with reference to FIGS. 24 and 25 may be performed by various computer devices, including the above-described integrated control apparatus 300 for multiple types of robots.

FIG. 24 is a diagram schematically showing a process of augmenting robot status information in an integrated control method for multiple types of robots according to another embodiment of the inventive concept.

Referring to FIG. 24, in step S810, the integrated control apparatus 300 for multiple types of robots identifies the first collection information of the robot status information received from a first robot of multiple types of robots.

Thereafter, in step S820, the integrated control apparatus 300 for multiple types of robots identifies an add-on device mounted on the first robot based on the identifier of the robot status information.

Thereafter, in step S830, the integrated control apparatus 300 for multiple types of robots determines whether there is an add-on device mounted on the first robot.

Thereafter, when there is the add-on device, the integrated control apparatus 300 for multiple types of robots identifies the second collection information of the device status information received from the add-on device mounted on the first robot in step S840.

Thereafter, in step S850, the integrated control apparatus 300 for multiple types of robots determines whether the first collected information and the second collected information overlap each other.

In some embodiments, in this case, when the first sensor that collected the first collection information and the second sensor that collected the second collection information are of the same type, the integrated control apparatus 300 for multiple types of robots may determine that the first collection information and the second collection information overlap each other.

Thereafter, in step S860, when the first collection information and the second collection information overlap each other, the integrated control apparatus 300 for multiple types of robots determines either the first collection information or the second collection information to be representative collection information based on preset priorities.

Thereafter, in step S870, the integrated control apparatus 300 for multiple types of robots generates augmented status information regarding the first robot.

When there is an add-on device mounted on the first robot and the first and second collection information overlap each other, the integrated control apparatus 300 for multiple types of robots may generate augmented status information regarding the first robot by merging the robot status information and the device status information based on the representative collection information.

Alternatively, when there is an add-on device mounted on the first robot and the first collection information and the second collection information do not overlap each other, the integrated control apparatus 300 for multiple types of robots may generate augmented status information regarding the first robot by merging the robot status information and the device status information based on the first collection information and the second collection information.

Alternatively, when there is no add-on device mounted on the first robot, the integrated control apparatus 300 for multiple types of robots may generate augmented status information regarding the first robot based solely on the robot status information.

Thereafter, in step S880, the integrated control apparatus 300 for multiple types of robots provides a user environment for the integrated control apparatus for multiple types of robots based on the augmented status information regarding the first robot.

Although not explicitly shown, identifying the first collection information of the robot status information received from the first robot of the multiple types of robots may include receiving robot status information in a unique format from the first robot and then performing the standardization conversion of the robot status information, received from the first robot, into a standard format.

Furthermore, generating the augmented status information regarding the first robot by merging the robot status information and the device status information may include generating augmented status information regarding the first robot by merging the standardization-converted robot status information and the device status information with each other.

FIG. 25 is a diagram schematically showing a process of augmenting a robot command in an integrated control method for multiple types of robots according to another embodiment of the inventive concept.

Referring to FIG. 25, in step S910, the integrated control apparatus 300 for multiple types of robots provides a user environment for the integrated control apparatus 300 for multiple types of robots based on information about an augmented command regarding a first robot of multiple types of robots.

Thereafter, in step S920, the integrated control apparatus 300 for multiple types of robots identifies the first function command of the augmented command regarding the first robot received from a user of the integrated control apparatus 300 for multiple types of robots.

Thereafter, in step S930, the integrated control apparatus 300 for multiple types of robots identifies an add-on device mounted on the first robot based on the identifier of the augmented command.

Thereafter, in step S940, the integrated control apparatus 300 for multiple types of robots determines whether there is an add-on device mounted on the first robot.

Thereafter, when there is the add-on device, the integrated control apparatus 300 for multiple types of robots determines whether the first robot or the add-on device mounted on the first robot can execute the first function command based on the registration information of the first robot and the add-on device in step S950.

Thereafter, when both the first robot and the add-on device can execute the first function command, the integrated control apparatus 300 for multiple types of robots determines either the first robot or the add-on device mounted on the first robot to be a representative device, which will execute the first function command, based on preset priorities in step S960.

Thereafter, in step S970, the integrated control apparatus for multiple types of robots generates a robot command or a device command.

When there is an add-on device mounted on the first robot and both the first robot and the add-on device can execute the first function command, the integrated control apparatus 300 for multiple types of robots may generate a robot command regarding the first robot or device command regarding the add-on device mounted on the first robot to execute the first function command of the augmented command based on the result of the determination of the representative device.

Alternatively, when there is an add-on device mounted on the first robot and the first robot cannot execute the first function command, the integrated control apparatus 300 for multiple types of robots may generate a device command regarding the add-on device mounted on the first robot to execute the first function command of the augmented command.

Alternatively, when there is an add-on device mounted on the first robot and the add-on device mounted on the first robot cannot execute the first function command, the integrated control apparatus 300 for multiple types of robots may generate a robot command regarding the first robot to execute the first function command of the augmented command.

Alternatively, even when there is no add-on device mounted on the first robot, the integrated control apparatus 300 for multiple types of robots may generate a robot command regarding the first robot to execute the first function command of the augmented command.

Thereafter, in step S980, the integrated control apparatus 300 for multiple types of robots transmits the command generated in the previous step. Based on the result the command generation in the previous step, the integrated control apparatus 300 for multiple types of robots transmits the robot command to the first robot or the device command to the add-on device mounted on the first robot.

Although not explicitly shown, generating the robot command regarding the first robot to execute the first function command of the augmented command may include generating a robot command in a standard format regarding the first robot to execute the first function command of the augmented command and performing the de-standardization conversion of the robot command in the standard format regarding the first robot into a format unique regarding the first robot.

In addition, transmitting the generated command may include transmitting the de-standardization-converted robot command to the first robot.

In some embodiments, the above-discussed method of FIGS. 24 and 25, according to this disclosure, is implemented in the form of program being readable through a variety of computer means and be recorded in any non-transitory computer-readable medium. Here, medium, embodiments, this in some contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIGS. 24 and 25 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the disclosed embodiment, the limitations caused by the differences in sensors or output devices between heterogeneous robots in an integrated control environment for multiple types of robots may be effectively overcome.

Furthermore, the information and functions required by an integrated control apparatus may be processed in a standardized format by compensating for the differences in sensors or output devices among manufacturers. This effectively resolves issues of information omission and functional limitations that are previously present across robots.

Furthermore, robots of various manufacturers may be allowed to provide the same user experiences and consistent quality by implementing an integrated control apparatus independent of the robot manufacturers. The operational efficiency of the control system may be increased and also consistency in the remote control and management of robots may be maintained by managing robot and device commands in an integrated manner.

Moreover, the inventive concept may resolve issues in the integrated control of heterogeneous robots, may effectively satisfy user needs by compensating for the omission or absence of robot functions, and may significantly improve the overall reliability and quality of services and systems.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. An integrated control apparatus for multiple types of robots for controlling multiple types of robots in an integrated manner, the integrated control apparatus for multiple types of robots for controlling multiple types of robots being configured to:
provide a user environment for the integrated control apparatus for multiple types of robots based on augmented command information regarding a first robot among the multiple types of robots;
identify a first function command of the augmented command regarding the first robot received from a user of the integrated control apparatus for multiple types of robots;
identify an add-on device mounted on the first robot based on an identifier of the augmented command;
determine whether the first robot or the add-on device mounted on the first robot can execute the first function command based on registration information of the first robot and the add-on device;
when both the first robot and the add-on device can execute the first function command, determine, based on preset priorities, either the first robot or the add-on device mounted on the first robot to be a representative device that will execute the first function command;
based on a result of the determination of the representative device, generate a robot command regarding the first robot or device command regarding the add-on device mounted on the first robot to execute the first function command of the augmented command; and
transmit the generated command.

2. The integrated control apparatus for multiple types of robots of claim 1, wherein the integrated control apparatus for multiple types of robots for controlling multiple types of robots is further configured to, when the first robot cannot execute the first function command, generate the device command regarding the add-on device mounted on the first robot to execute the first function command of the augmented command.

3. The integrated control apparatus for multiple types of robots of claim 1, wherein the integrated control apparatus for multiple types of robots for controlling multiple types of robots is further configured to, when there is no add-on device mounted on the first robot or the add-on device mounted on the first robot cannot execute the first function command, generate the robot command regarding the first robot to executing the first function command of the augmented command.

4. The integrated control apparatus for multiple types of robots of claim 3, wherein the integrated control apparatus for multiple types of robots for controlling multiple types of robots is further configured to:
generate a robot command in a standard format regarding the first robot to execute the first function command of the augmented command;
perform de-standardization conversion of the robot command in the standard format regarding the first robot into a format unique regarding the first robot; and
transmit the de-standardization-converted robot command to the first robot.

5. The integrated control apparatus for multiple types of robots of claim 1, wherein the add-on device comprises one or more output devices or one or more actuators.

6. An integrated control method for multiple types of robots for controlling multiple types of robots in an integrated manner, the integrated control method for multiple types of robots for controlling multiple types of robots comprising:
providing a user environment for the integrated control apparatus for multiple types of robots based on augmented command information regarding a first robot among the multiple types of robots;
identifying first function command of the augmented command regarding the first robot received from a user of the integrated control apparatus for multiple types of robots;
identifying an add-on device mounted on the first robot based on an identifier of the augmented command;
determining whether the first robot or the add-on device mounted on the first robot can execute the first function command based on registration information of the first robot and the add-on device;
when both the first robot and the add-on device can execute first function command, the determining, based on preset priorities, either the first robot or the add-on device mounted on the first robot to be a representative device that will execute the first function command;
based on a result of the determination of the representative device, generating a robot command regarding the first robot or device command regarding the add-on device mounted on the first robot to execute the first function command of the augmented command; and
transmitting the generated command.

7. The integrated control method for multiple types of robots of claim 6, further comprising, when the first robot cannot execute the first function command, generating the device command regarding the add-on device mounted on the first robot to execute the first function command of the augmented command.

8. The integrated control method for multiple types of robots of claim 6, further comprising, when there is no add-on device mounted on the first robot or the add-on device mounted on the first robot cannot execute the first function command, generating the robot command regarding the first robot to executing the first function command of the augmented command.

9. The integrated control method for multiple types of robots of claim 8, wherein:
generating the robot command regarding the first robot to executing the first function command of the augmented command comprises generating a robot command in a standard format regarding the first robot to execute the first function command of the augmented command and performing de-standardization conversion of the robot command in the standard format regarding the first robot into a format unique regarding the first robot; and
transmitting the generated command comprises transmitting the de-standardization-converted robot command to the first robot.

10. The integrated control method for multiple types of robots of claim 6, wherein the add-on device comprises one or more output devices or one or more actuators.
